(19) United States
(12) Patent Application Publication
(10) Pub. No.: US 2022/0038573 A1
(43) Pub. Date: Feb. 3, 2022

(54) Downloadable Application Composite with Built In User Interface

(71) Applicant: Kevin L. Gatlin, Atlanta, GA (US)

(72) Inventor: Kevin L. Gatlin, Atlanta, GA (US)

(21) Appl. No.: 16/941,194

(22) Filed: Jul. 28, 2020

(51) Int. Cl. H04M 1/725; G06F 3/0481

(52) U.S. Cl. CPC H04M 1/72586; G06F 3/0481

(57) ABSTRACT

A system for enhancing mobile devices performance operates on a network-connected server with software executing from a non transitory medium at the server providing an interactive interface for a user connected to the server via an application composite download. The application composite offers search radius capabilities displayed on a navigation screen. There is also a data repository coupled to the server. The data repository with interactive interface provides an organizer for applications where applications can be saved in an end-user's composite or stored in a recent history folder for immediate recall. The interactive interface provides an application search point for the end-user to gain access to countless applications in lieu of downloads. The application composite is used for improving performance by eliminating battery drainage by freeing up space on the internal storage mechanism in the mobile device.

### BACKGROUND OF THE INVENTION

### 1. Field of the Invention

The present invention is in the field of a downloadable application in the form of a composite and pertains particularly to mobile devices for optimizing the user's experience in the advent of excessive downloads of mobile applications.

### 2. Description of Related Art

Applications for smart phones, and other mobile devices of many different descriptions and manufacture, are known in the art. There are, in the present inventor's opinion, many shortcomings that might be provided to improve the utility of such mobile devices. Enhancements and improvements according to embodiments of the present invention are provided and described in enabling detail below and apply to all such mobile devices.

### 3. Discussion of the State of the Art

We are amidst an application revolution, an increasingly crowded space for businesses. There are 834,861 application publishers, 2,843,123 applications to date and an average of 5092 new applications released every day. With multinational companies having as many as (5) five or more applications each to cover their global reach, our need for applications are growing each year.

The contemporary methodology and utilization of mobile devices will become increasingly antiquated as our dependency on application use grow. There are between 60 and 90 applications installed on the average smartphone and mobile device today, which challenges the restriction and limitations of the internal storage unit of the device.

With the advent of applications, the embodiment of the invention demonstrates a more modernized approach of the usage of mobile devices by revealing how simple the one application methodology is as opposed to the antiquated system of operation which exists today having to download applications one at a time into the internal storage mechanism of the mobile device to gain access to them. Furthermore, the invention eases constraints that are caused by excessive downloads. The Application Composite helps the performance of mobile device run smoother while allowing the end-user full access to endless applications.

The invention will demonstrate why some applications are meant to be used sparsely as opposed to being permanent and therefore should not require a download to the mobile device's internal storage mechanism to gain access to it. This invention will also show why an application portal to a composite is more practical and demonstrates why the methodology of sourcing applications from app stores moving forward will not make sense as applications use become more and more prevalent for mobile devices.

The user interface embedded within the application is equipped with a composite for application organizing and storage, with a search engine and search radius optimization apparatus allowing the mobile device free flowing usage to global positioning satellite (GPS) coordinates and mapping, which highlights a predominant reason why mobile devices became a necessity; proximity and mobility. Moreover, the unique user interface is designed to feature applications and websites in tile form, having unlimited accessibility to each thus eliminating the need to download. All applications will be stored in a personal composite for instant recall for usage and/or disposal at the end user's discretionary time.

### SUMMARY OF THE INVENTION

In one embodiment of the present invention, an apparatus shows the downloaded application on a contemporary mobile's home screen. In another embodiment a pre-signup screen displays a selection of the languages the application can communicate in. The names of the languages are comprised in a directory format, allowing the end-user to scroll upward and downward toward the language of choice. A checkmark appears beside the language of choice signifying the desired selection. Across the top are options to select cancel or complete with the word “done” to exit the screen.

In one embodiment, the apparatus further displays a popup keyboard for typing in information on a signup screen, revealing boxes for the end-user's first and last name, email address, username, password, a password confirmation, a privacy agreement box, and signup authorization button. The signup screen scrolls upward to complete the task.

In one embodiment of the invention shows a welcome screen introducing various new applications for the end-user to choose from. The applications on this welcome screen allow the end-user to browse across a wide array of applications the composite imagine may interest the end-user.

In one embodiment shows what a screen may look like when an application in the welcome has peeked the interests of the end-user. The presentation shows an application icon and picture along with instructions and incentives to save in the end-user's application composite.

In one embodiment of the invention, the Home Screen inside the Application Composite displays a heading for both favorite and recent applications, entitled Favorites/Apps and Recents/Apps respectably. This embodiment of the invention is an example of what a home screen may look like for a new end-user demonstrating no stored applications or recently visited applications stored in the Application Composite. Seven navigation toggles also appear on the screen of the apparatus. In no particular order, A Home Symbol signifying Home Screen, a Gear Symbol signifying settings, the Reverse Arrows Symbol in of each other signifying switching from applications to website icons, a Star Symbol signifying favorites section for applications, the Book Symbol signifying a recent history of stored applications, the Cloud Symbol signifying the Application Composite, and the Plus Symbol signifying search.

In one embodiment of the invention, the Home Screen is a heading for both favorite and recent applications, entitled Favorites/Apps and Recents/Apps Grouping, respectively. In this illustration it shows an example of what a home screen may look like for a more experienced end-user demonstrating several rows of applications in a Grouping displayed under Favorites/Apps and several rows of applications in a Grouping displayed under Recents/Apps. In one embodiment of the invention the favorites and recents applications may be displayed in alphabetized order. In one embodiment of the invention the favorites and recents applications may be displayed in a chronicled order or by category. The order of the applications displayed are at the end-user's discretion.

In one embodiment, the Home Screen is an exclusive listing of the favorites applications in a Grouping. In another embodiment the Home Screen is a complete listing of the recents applications in a Grouping.

In one embodiment of the present invention, is a screen entitled App Composite, the abbreviation for application composite. In the embodiment below the title App Composite shows a listing of the Primary Categories the applications may be saved or stored under. In one embodiment the Primary Categories are as follow: Book, Business, Catalogs, Education, Entertainment, Finance, Food & Drink, Games, Health & Fitness, Kids, Lifestyle, Medical, Music, Navigation, News, Newsstand, Photo & Video, Productivity, Reference, Social Networking, Sports, Travel, Utilities, and Weather. In another embodiment the number of applications stored under each Primary Category may be displayed in parentheses adjacent to each name respectably.

In one embodiment the display reveals a comprehensive list of Sub-Categories that may be listed under a category. In one embodiment a cursor may highlight the name of the selected Sub-Category. The embodiment may also show the various navigation toggles to exit the screen.

In one embodiment of the present invention may appear the name of the Primary Category at the top with the Sub-Category listed directly below. Underneath the Sub-Category may appear numerous titles of various applications with the name underneath in a row format. The display may also show the various navigation toggles to exit the screen.

In one embodiment may appear a different format and display of Primary Categories. In this embodiment cursor also highlights the selected Primary Category to open. In one embodiment below the Primary Categories section is a Favorites/Apps Grouping displaying several rows of applications. In one embodiment below the Primary Categories section is a Recents/Apps Grouping displaying several rows of applications. This embodiment the screen is displayed with a back button below the Favorites/App Grouping and (7) seven or so different navigation toggles to exit from the screen.

In one embodiment of the present invention, the Application Composite shows the selected category opened; in this instance the selected category is entitled Utilities. In the embodiment the various applications stored under the selected category, Utilities are displayed. In the embodiment below the selected category section is a Favorites/Apps Grouping displaying several rows of applications displayed underneath. In one embodiment a utilities application is dragged from the selected category down to the Favorites/Apps Grouping.

In one embodiment a utilities application may be displayed in both the Utilities category as well as the Favorites/Apps Grouping. Also, in one embodiment may display a back button underneath the Favorites/Apps Grouping and (7) seven or so different navigation toggles to exit from the screen.

In one embodiment of the invention, is an interface with search radius options. The embodiment has two boxes. The first box may display a search window for products, services, and businesses. The second box may display a radius window for selecting the proximity and distance from the product, service, or business. If the distance of the search is required, a radius window with a dropdown screen may display four options: within feet, within 1 mile, within 10 miles, or within 100 miles. Also, in one embodiment, may exhibit an icon of a microphone giving the end-user a voice option to search. If you choose to manually type in the name of the product, service, or business, one may be able to tap inside the first box will display a keyboard to complete the task. In the embodiment, one may be able to tap inside the microphone icon to activate and deactivate the option for voice command. Also, in one embodiment it may display (7) seven or so different navigation toggles to exit from the screen.

In one embodiment along with the search radius options may reveal of a Favorites/Apps Grouping below a microphone giving the end-user access to saved applications. In one embodiment along with the search radius options show a Recent/Apps Grouping below the microphone which may give the end-user access to recently visited applications. In another embodiment along with the search radius options is an illustration of both a Favorites/Apps Grouping and a Recents/Apps Grouping giving the end-user complete access to both saved and recently visited applications together. Also, in one embodiment displays a (7) seven or so different navigation toggles to exit from the screen.

In one embodiment it may show the search results of a product, service, or business in application form. In one embodiment each application may reveal the name and distance below the applications listed. In one embodiment the applications of fast food restaurants may display application in order of closes to farthest in distance within the 10-mile radius on the mobile device. In one embodiment it may show the search results of fast food restaurants within a 10-mile radius accompanied with a media streaming window used for search advertisement. In one embodiment it may reveal the search results of fast food restaurants within a 10-mile radius, with a media streaming window that may be described as a flash, html, or means for search advertisement, along with a demonstration of a Favorites/Apps Grouping on the present invention. In one embodiment it may show the search results of fast food restaurants within a 10-mile radius, a media streaming window used for search advertisement, and a display of a Recent/Apps Grouping shown on the present invention. In another embodiment it may show the search results of fast food restaurants within a 10-mile radius, a media streaming window used for search advertisement, and a display of both a Favorites/Apps Grouping and a Recent/Apps Grouping together on the present invention.

In another embodiment a fast food application may be dragged from the search results of fast food restaurants down to the Favorites/Apps Grouping. In one embodiment the fast food application may be displayed in both the fast food search results as well as the Favorites/Apps Grouping.

In another embodiment it may show a burger restaurant selected from the list of search results of fast food restaurants within a 10-mile radius. In each of the above embodiments on this paragraph displays the (7) seven or so different navigation toggles to exit from the screen at a moment notice.

In one embodiment is a brand's navigation screen may be rendered from the search results. In the embodiment the brand's navigation screen may display several icons comprising the brand's footprint and reach.

In one embodiment the brand's logo and name at the top may be accompanied with icons of the brand's various apps, weblinks, locations, and deals. In one embodiment is the brand's landing page that may show the brand's footprint coupled with a Favorites/Apps Grouping of the on the screen.

In one embodiment is the brand's navigation screen may display the brand's footprint coupled with a Recents/Apps Grouping of the on the screen. In one embodiment may reveal a brand's navigation screen showing the brand's footprint coupled with a Favorites/Apps Grouping and a Recents/Apps Grouping of the on the display together. A back button may also be shown at the bottom with the (7) seven or so different navigation toggles to exit from the screen at a moment notice.

In one embodiment of the invention, it may reveal a complete list of applications registered under a brand's name. The top of the screen may display the brand's name with the abbreviation of the word application at the top followed by a list of the various applications the brand created.

In one embodiment of the present invention is a generic brand name “Burger Box”. The list of applications examples listed under the generic brand name “Burger Box” may show an application the brand created for its customer base, a second application the brand created for its corporate structure, a third application the brand created for its special interest (in this embodiment kids), a fourth application the brand created for its supply chain (shipping and logistics to its locations), and fifth application the brand created for its foundation (the numerous charities its involved in).

In one embodiment the various applications may reveal different logos on each application icon, a brief description of the application below the icon, a star rating of the application below description, and an open button beside the name, description, and rating.

In one embodiment is may display a back button shown below the various applications, and a display of a Favorites/Apps Grouping below the back button at the bottom of the screen.

In another embodiment may show a display of a Recents/Apps Grouping at the bottom of the screen. In another embodiment it may reveal both a display of a Favorites/Apps Grouping, and a Recents/Apps Grouping together at the bottom of the screen. In each of the above embodiments of the present display (7) seven or so different navigation toggles to exit from the screen at a moment notice.

In one embodiment of the present invention may display a home screen of an opened application exhibited with a Favorites/Apps Grouping at the bottom of the screen. In one embodiment of the present invention may be a home screen of an opened application displayed with a Recents/Apps Grouping at the bottom of the screen. In another embodiment the present invention may exhibit both a screen with a Favorites/Apps Grouping, and a Recents/Apps Grouping together along the bottom. In each of the above embodiments of this paragraph may display (7) seven or so different navigation toggles to exit from the screen at a moment notice.

In one embodiment, may reveal a list of the various weblinks found under a brand's name in icon form. The top of the screen may display the brand's name with the abbreviation of the word website at the top followed by a list of search results generated on the web for the brand. In one embodiment of the present invention is a generic brand name “Burger Box”. The list of web icons listed under “Burger Box” may show an icon created for the brand's website, a second web icon created for the brand YouTube presence, a third web icon created for the brand Twitter presence, a fourth web icon created for the brand charitable presence, and a fifth web icon created for online events and live stream. In one embodiment it may reveal a back button shown below the various web icons, and a display of a Favorites/Apps Grouping below the back button at the bottom of the screen. In another embodiment shows a display of a Recents/Apps Grouping at the bottom of the screen. In another embodiment it may display a Favorites/Apps Grouping, and a Recents/Apps Grouping together at the bottom of the screen. In each of the above embodiments it may display (7) seven or so different navigation toggles to exit from the screen at a moment notice.

In one embodiment of the present invention may reveal a home screen of a website displayed with a Favorites/Apps Grouping at the bottom of the screen. In one embodiment of the present invention may reveal a home screen of an opened application exhibited with a Recents/Apps Grouping at the bottom of the display. In another embodiment it may show a display of a Favorites/Apps Grouping, and a Recents/Apps Grouping together at the bottom of the screen. In each of the above embodiments of this paragraph may display (7) seven or so different navigation toggles to exit from the screen at a moment notice.

In one embodiment of the invention, may reveal a list of the various nearby locations found under a brand's name in icon form. The top of the screen may display the brand's name with the word Locations at the top followed by a list of locations in icon form for the brand. In one embodiment of the present invention is a generic brand name “Burger Box”. The list of location icons listed under “Burger Box” may display in proximity and distance from the mobile device. In one embodiment the various location icons, may have the name of the brand, the brand's address, and the estimated distance from the mobile device. In one embodiment may reveal a back button shown below the various location icons, and a display of a Favorites/Apps Grouping below the back button at the bottom of the screen. In another embodiment it may display a Recents/Apps Grouping at the bottom of the screen. In another embodiment may show both a display of a Favorites/Apps Grouping, and a Recents/Apps Grouping together at the bottom of the screen. In each of the above embodiments it may display (7) seven or so different navigation toggles to exit from the screen at a moment notice.

In one embodiment of the invention, the information may include global positioning satellite (GPS) data indicating the location of the mobile device in proximity from the selected location. In one embodiment may be a back button shown below the map and directions, and a display of a Favorites/Apps Grouping below the back button at the bottom of the screen. In another embodiment it may reveal a display of a Recents/Apps Grouping at the bottom of the screen. In another embodiment it may show both a display of a Favorites/Apps Grouping, and a Recents/Apps Grouping together at the bottom of the screen. In each of the above embodiments it may display (7) seven or so different navigation toggles to exit from the screen at a moment notice.

In one embodiment of the present invention may reveal a screen with a list of coupons with QR codes. In one embodiment it may display a back button exhibited below the list of coupons with QR codes, along with a display of a Favorites/Apps Grouping below the back button at the bottom of the screen. In another embodiment it may reveal a display of a Recents/Apps Grouping at the bottom of the screen. In another embodiment may reveal both a display of a Favorites/Apps Grouping, and a Recents/Apps Grouping together at the bottom of the screen. In each of the above embodiments it may also display (7) seven or so different navigation toggles to exit from the screen at a moment notice.

### BRIEF DESCRIPTION OF THE SEVERAL VIEWS OF THE DRAWINGS

Other advantages of the present disclosure will be readily appreciated, as the same becomes better understood by reference to the following detailed description when considered in connection with the accompanying drawings wherein:

Non-limiting and non-exhaustive embodiments of the present invention are described with reference to the following figures, wherein like reference numerals refer to like parts throughout the various views unless otherwise specified.

FIG. 1 is an illustration of an exemplary home screen presented to various users when the app composite is downloaded on their mobile device in one embodiment of the present invention.

FIG. 2 is an illustration of a language selection screen in an embodiment of the invention.

FIG. 3 is an illustration of a sign-up screen in an embodiment of the invention.

FIG. 4A is an illustration of a sign-up screen with pop-up keyboard in an embodiment of the invention.

FIG. 4B is an illustration of a sign-up screen with pop-up keyboard displaying the enter button in an embodiment of the invention.

FIG. 5 is an illustration of settings screen with various icons displayed for the end-user to augment to her specifications while inside of the application composite.

FIG. 6A is an illustration of a welcome window or screen that displays various applications the interface deems the end-user may have interest in.

FIG. 6B is an illustration of a selected advertisement being viewed by the end-user. The illustration also depicts a solicitation and incentive to entice the end-user to save the application in the composite.

FIG. 6C is an illustration of an exemplary home screen of a new end-user inside the application composite presented to a user when the app composite is downloaded on their mobile device in one embodiment of the present invention.

FIG. 7 is an illustration of an exemplary home screen of a more experienced end-user showing both the favorite applications and recent applications inside the application composite is downloaded on their mobile device in one embodiment of the present invention.

FIG. 8 is an illustration of an exemplary home screen of an experienced user displaying a menu of all the favorite applications stored in the composite on the mobile device in one embodiment of the present invention.

FIG. 9 is an illustration of an exemplary home screen of an experienced user displaying a menu of all the recent applications recalled in the composite on the mobile device in one embodiment of the present invention.

FIG. 10A illustrates a full menu of the various Primary Categories which applications can be browsed in the application composite along with viewing of a Favorites/Apps Grouping below category classifications inside the application composite system.

FIG. 10B illustrates a comprehensive library of Sub-Categories that may be listed under a Primary Category.

FIG. 10C illustrates a selected Sub-Category Brides and Weddings with examples of various titles of applications that could be opened and/or saved by the end-user.

FIG. 11 illustrates a list of Primary Categories with a selected category highlighted with a cursor in this instance utilities displayed along with a Favorites/Apps Grouping below the opened category.

FIG. 12 is an illustration displaying one of the applications stored in the Utilities category being dragged down to the Favorites/Apps Grouping to remain saved in the user's favorites in an embodiment of the present invention.

FIG. 13 is an illustration of an exemplary home screen demonstrating both the Favorites/Apps and Recent/Apps Groupings with the newly dragged utility application dragged down in FIG. 12 appearing in the Favorites/App Grouping on their mobile device in one embodiment of the present invention.

FIG. 14 is an illustration of an interactive interface of a search radius screen in an embodiment of the invention.

FIG. 15 is an illustration of an interactive interface of a search radius screen using the typing option for searching for fast food within a 10-mile radius in one embodiment of the present invention.

FIG. 16 is an illustration of an interactive interface of a search radius screen using the voice activated option for searching for fast food within a 10-mile radius in one embodiment of the present invention.

FIG. 17 is an illustration of an interactive interface of a search radius screen right before you enter the search for fast food within a 10-mile radius in one embodiment of the present invention.

FIG. 18 is an illustration of an interactive interface showing the search results of for fast food restaurants within a 10-mile radius along with a search advertisement shows one of the fast food applications from the search results being dragged down to the Favorites/Apps Grouping to remain saved in the user's favorites in an embodiment of the present invention.

FIG. 19 is an illustration of an interactive interface showing the search results of for fast food restaurants within a 10-mile radius along with a search advertisement shows one of the fast food applications “The Burger Box” being selected to open from the search results in an embodiment of the present invention.

FIG. 20 illustrates a navigation screen for a person (end-user) after selecting an application (in this instance The Burger Box) from the search results.

FIG. 21 illustrates a list of applications found under the selected brand's name showing the Favorites/Apps Grouping below in an embodiment of the invention.

FIG. 22 is an illustration of a home screen of an opened application showing the favorites/Apps Grouping below in an embodiment of the invention.

FIG. 23 illustrates a list of website icons created under a selected brand's name showing the Favorites/Apps Grouping below in an embodiment of the invention.

FIG. 24 is an illustration of a home screen of a brand's webpage showing the Favorites/Apps Grouping below in an embodiment of the invention.

FIG. 25 is an illustration of a list of locations within a 10-mile radius from the mobile device, showing the Favorites/Apps Grouping below the list of locations in an embodiment of the invention.

FIG. 26 is an illustration of a GPS coordinates mapping system from the mobile device, showing the Favorites/Apps Grouping below the mapping system in an embodiment of the invention.

FIG. 27 is an illustration of a brand's coupons with QR codes from the mobile device, showing the Favorites/Apps Grouping below the coupons in an embodiment of the invention.

FIG. 28 is an illustration of a brand's coupons with QR codes from the mobile device, showing the Recent/Apps Grouping below the coupons in an embodiment of the invention.

FIG. 29 is an illustration of a brand's coupons with QR codes from the mobile device, showing both the Favorites/Apps Grouping on top of the Recent/Apps Grouping below the coupons in an embodiment of the invention.

FIG. 30 is an illustration of a brand's coupons with QR codes from the mobile device, showing both the Recent/Apps Grouping on top of the Favorites/Apps Grouping below the coupons in an embodiment of the invention.

FIG. 31 is an illustration of an exemplary home screen showing the updated applications, newly displayed in both the favorites and recent application Groupings on the mobile device in one embodiment of the present invention.

FIG. 32 is an illustration of an exemplary home screen showing a display similarly to FIG. 31, except the recents applications are displayed on top of the favorites applications.

FIG. 33 is an illustration of an exemplary application composite screen revealing multiple applications opened on a single display with a Favorites Apps/Grouping and Recents/App Grouping shown below the multiple opened applications.

FIG. 34 is an illustration of an exemplary flowchart showing the how the present invention works between the various features.

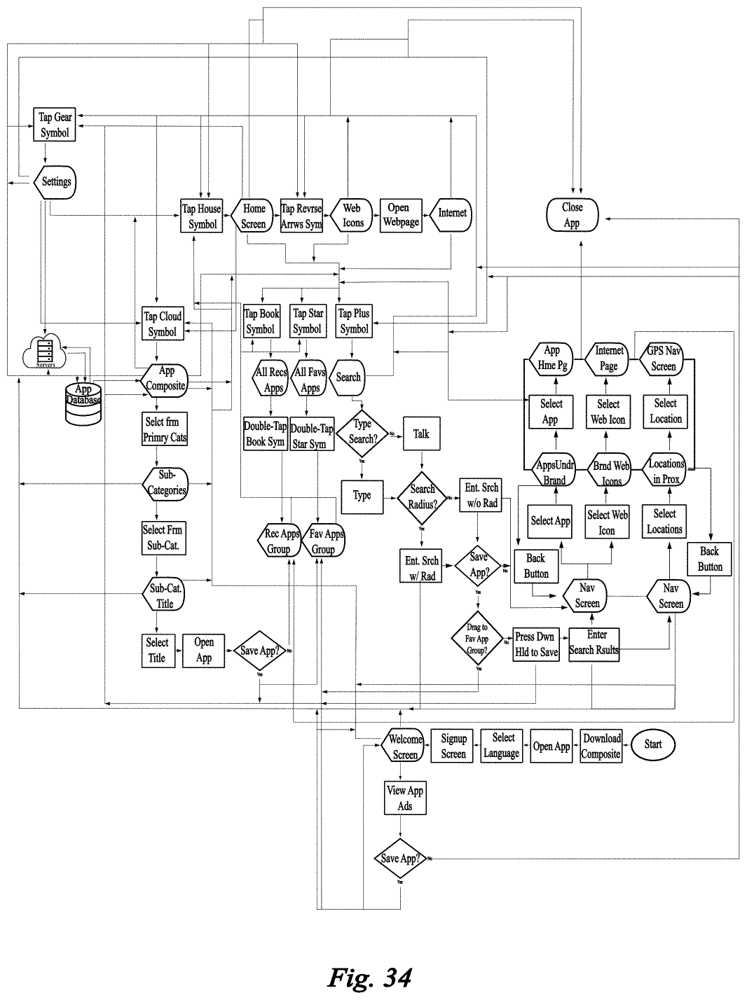

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION OF THE INVENTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

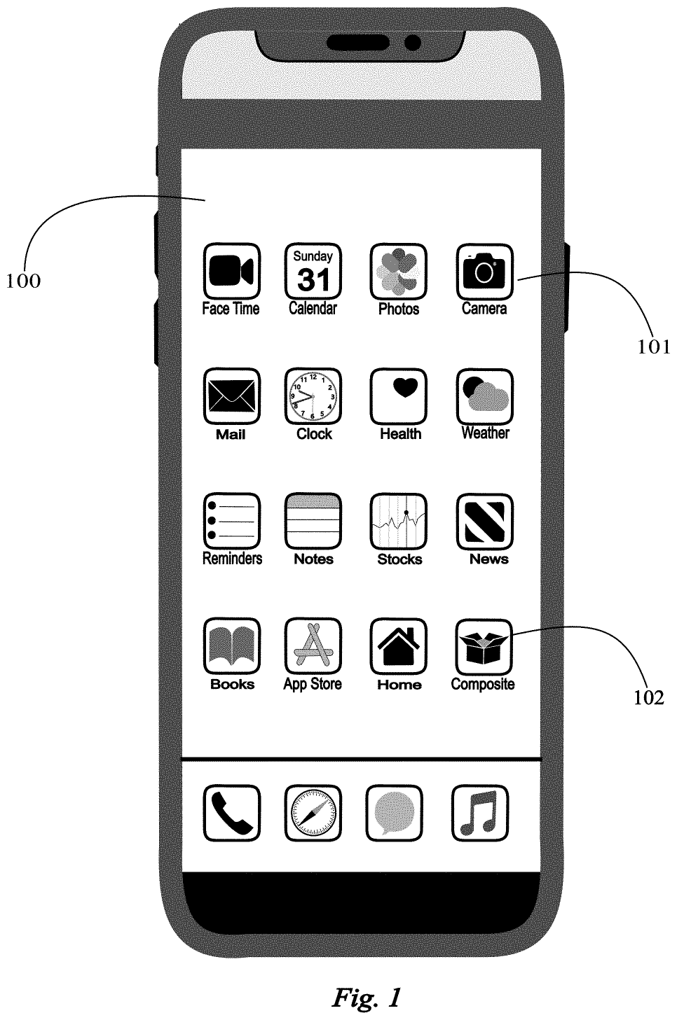

FIG. 1 is an architectural diagram illustrating an exemplary home screen 100 of a typical mobile device in one embodiment showing numerous application downloads 101 from an app store according to an embodiment of the present invention. FIG. 1 also shows a possible icon of the Application Composite 102 as a downloaded application on the mobile device's home screen 100 likewise downloaded from an app store.

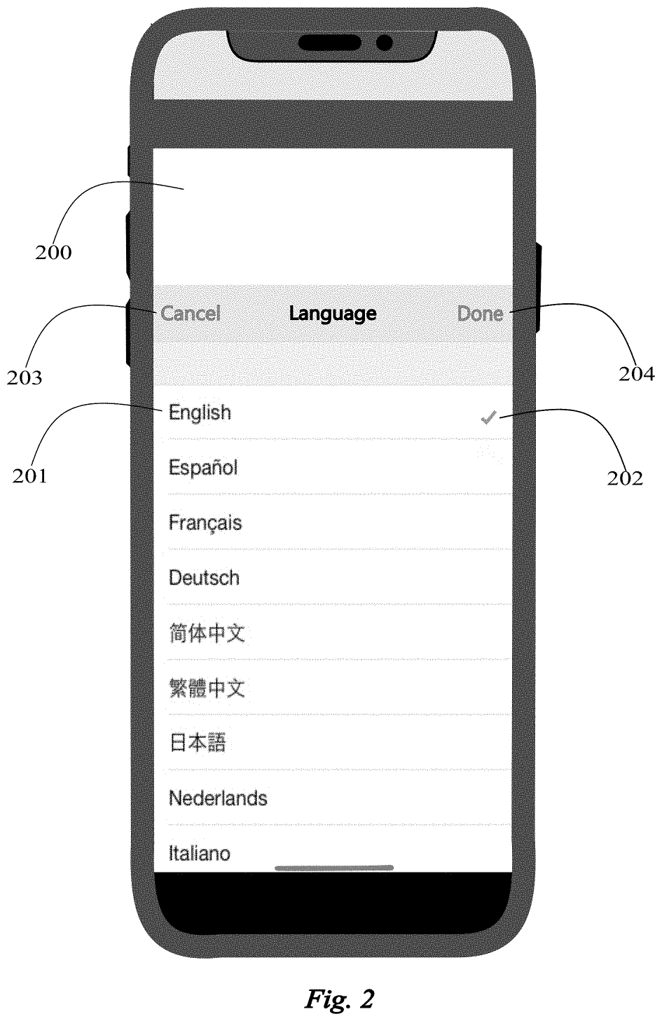

FIG. 2 is an illustration of an exemplary language selection screen 200 which may showcase a list of languages 201 displayed along the left-hand side of the screen, that the end-user may be able to choose to communicate inside the Application Composite 102. A check mark 202 or similar mark may appear along the language of choice the end-user chooses to communicate with in Application Composite 102. If the end-user elects to cancel for whatever reason at this juncture a “Cancel” image 203 may appear above the list of languages 201 to exit the language selection screen 200.

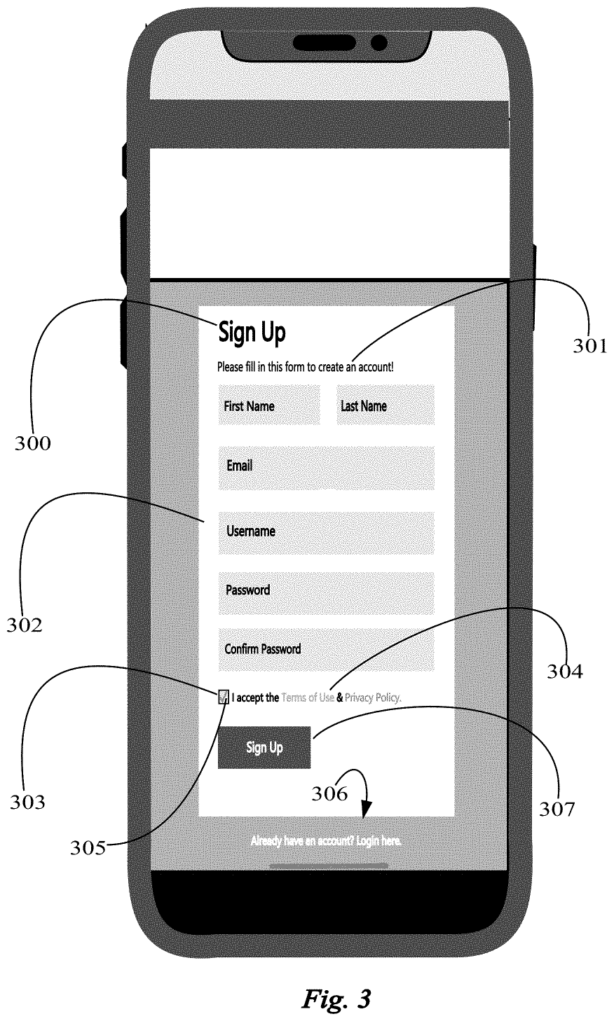

Upon the completion of the selection of the language may be a “Done” image 204, exhibited alongside a possible “Cancel” icon 203, which may send the end-user to a signup screen 300 illustrated in FIG. 3 according to an embodiment of the present invention.

The signup screen 300 may display a set of boxes to type for basic user credentials. Above the set of boxes may be the wording, “Please fill in this form to create an account!” 301 or a similar phrase. There is a Sign-up function 302 where an end-user may enter a first name, last name, email address, username, password, and password conformation to access the Application Composite 102.

A small box 303 may sit below the set of boxes or in another convenient placement that required the end-user's credentials in the Sign-up function 302, which indicate compliance with the terms of use and policy 304 while using the Application Composite 102. A checkmark 305 or another distinct Symbol inside the box implies that the end-user is in full agreeance with those terms. If the end-user already has an account and for some reason is having difficulties logging into her Application Composite 102 there may be a section at the bottom of the screen or position in some other location inquiring if the end-user already have an account. There may be a simple gesture like “already have an account? Login here” 306 indicating the end-user may have previously established an account. Pushing the “Sign Up” button 307 or its equivalent may be the final step towards creating an account with the Application Composite 102.

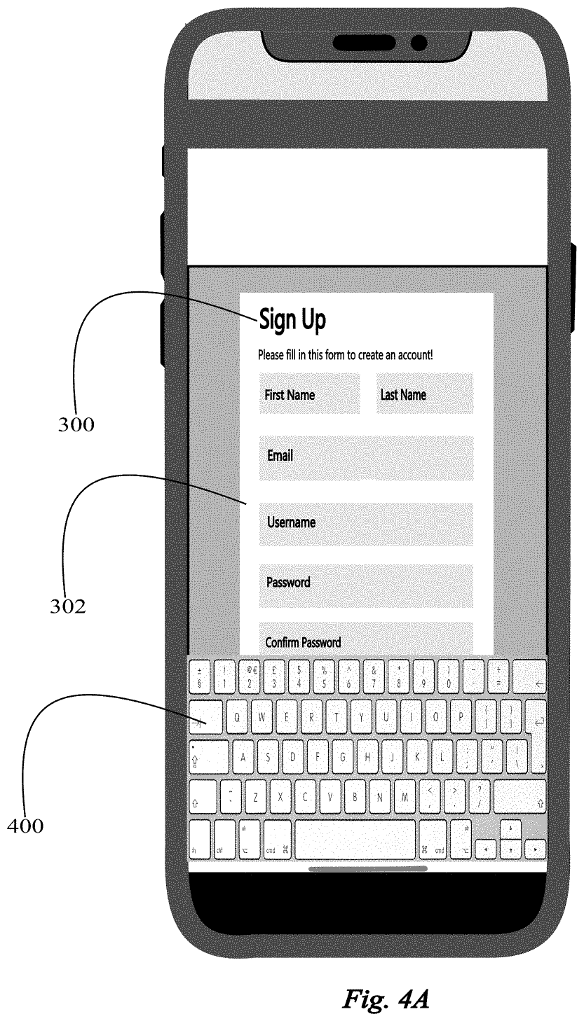

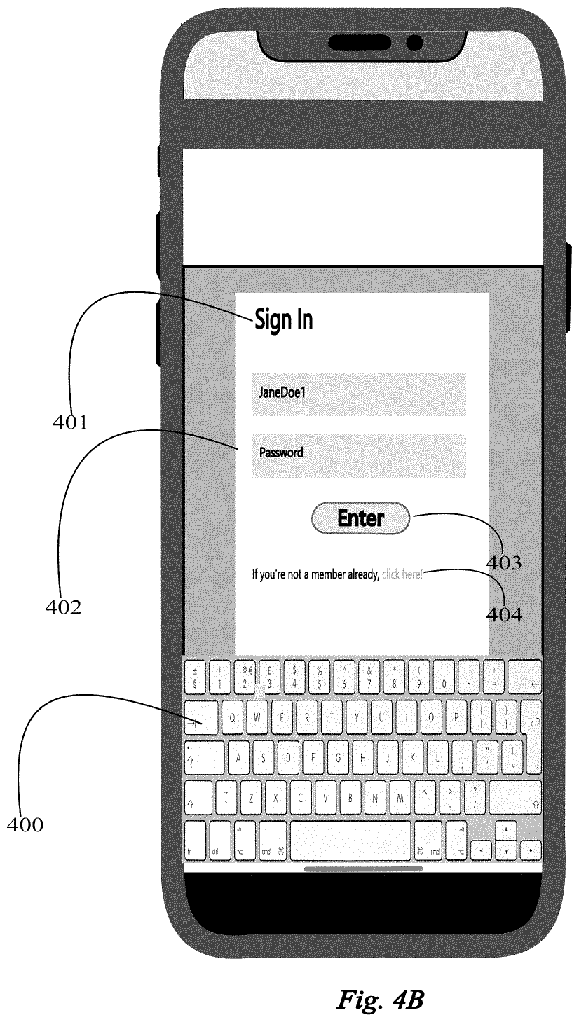

A popup keyboard 400 may appear after the end-user taps inside the window to type in her credentials shown in FIG. 4A. The popup keyboard may disappear after the end-user confirms the correct password according to an embodiment of the present invention. After the end-user's information is filled into the appropriate boxes an enter button 403 may appear to gain access to the interface as a new user shown in FIG. 4B.

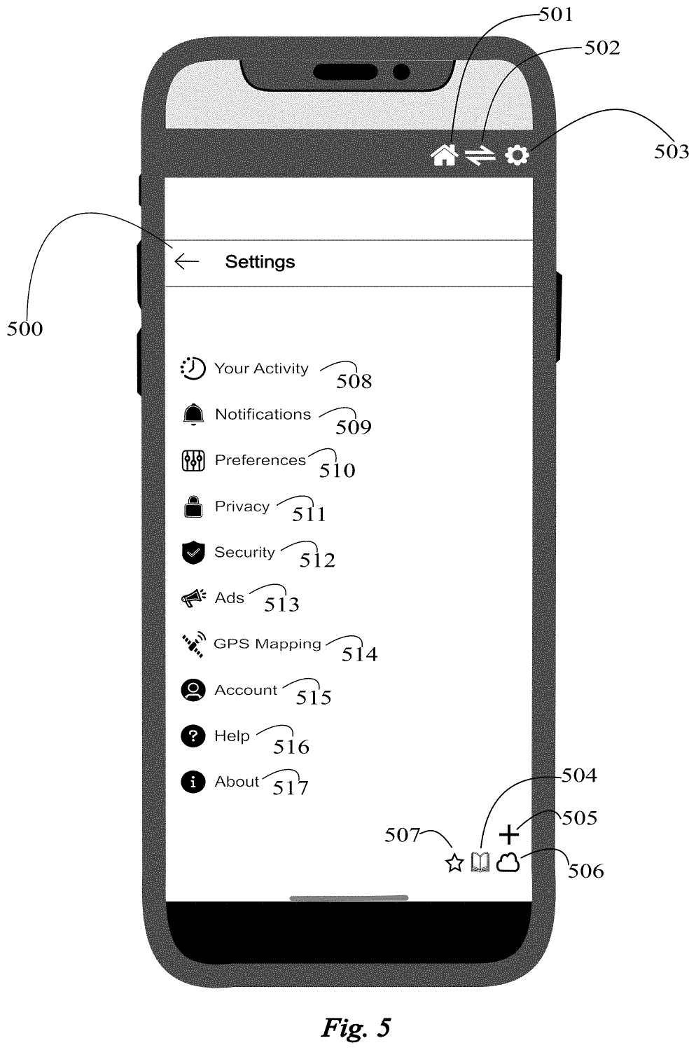

FIG. 5 Illustrates the Settings Screen 500 inside the Application Composite 102. The Setting Screen 500 may be the central navigation panel for user preferences. There may be in upwards of seven or more primary navigation toggles which are displayed throughout the user interface illustrated in FIG. 5. At the very top of the display may display a Symbol of a house 501, which may route the end-user to her home screen. The Reverse Arrows Symbol 502 which may switch the end-user from applications to web-based icons and vice versa, Gear Symbol 503 may be the Symbol for settings, which may navigate you to the settings screen 500. Book Symbol 504 may reveal the recent history of visited applications that are not stored in the Application Composite 102. Towards the bottom of the screen may display a Plus Symbol 505 which may be utilized for searching applications and web-based icons. The Cloud Symbol 506 may be a direct link to the Application Composite 102, Star Symbol 507 may be an icon to recall favorites applications. Favorites applications may be those the end-user chooses to save as favorites. These applications may be retrieved easily from the Application Composite 102. The Settings Screen 500 may also list another set of Symbols. The accessibility of these ten more or less icons may be limited exclusively to the settings area of the Application Composite 102. The Clock Symbol 508 may be an icon for “Your Activity”. “Your Activity” may keep track of the end-user's footprint while logged inside of the Application Composite 102. “Your Activity” may reveal a timeline and sequence of events the end-user journals while being logged into the Application Composite 102. “Your Activity” may record the time, date, and other pertinent data each time the application is visited. This feature may also capture the sequence in which the application was visited in conjunction with other applications. For instance, if the end-user is directed from the Application Composite 102 to another section within the Application Composite 102, it may be recorded inside the “Your Activity” section. This information can be utilized to recommend similar applications the end-user has not frequented.

The Bell Symbol 509 is for “Application Notifications”, the end-user may be able to limit certain communication with applications she chooses at her discretion.

Knob Symbol 510 may show a lever for “Preferences”. Preferences in the Application Composite 102 may allow the end-user to augment a distinctive look, feel, and design to her Application Composite 102.

The Lock Symbol 511 may protect the “Privacy” of the end-user when needed. The end-user may want to restrict certain activity while inside of the Application Composite 102.

Shield Symbol 512 may perhaps represent “Security”. Security could be where the username and passwords of all the applications are stored. Any pertinent financial data i.e. credit card information etc. may be found here.

Bullhorn Symbol 513 may be the icon for “Ads.” The end-user may be afforded certain levels of autonomy and privacy from advertisements while visiting applications. The end-user may be able to pay to bypass certain advertisements here while navigating between individual applications.

The Satellite Symbol 514 may Symbolize “GPS Mapping.” The end-user may limit access to geofencing, geolocation, and geo marketing with the click of a switch inside the GPS Mapping icon.

The Person Symbol 515 may be the end-user's Application Composite 102 account. The Application Composite 102 account may be where the end-user's pertinent information is stored. Name, address, phone number, and other general information may be accessed and updated at the end-user's discretion.

The Question Mark Symbol 516 may be an access point for help. (FAQ) Frequently asked questions may be found here to aid the end-user's experience as well as a possible chat room for questions not found and answered in the FAQ, that the end-user may have.

Lastly, the 10^{th} Symbol shown in FIG. 5 is Lowercase I Inside a Circle Symbol 517 which may be where basic information about the company is stored and other general information about the Application Composite 102.

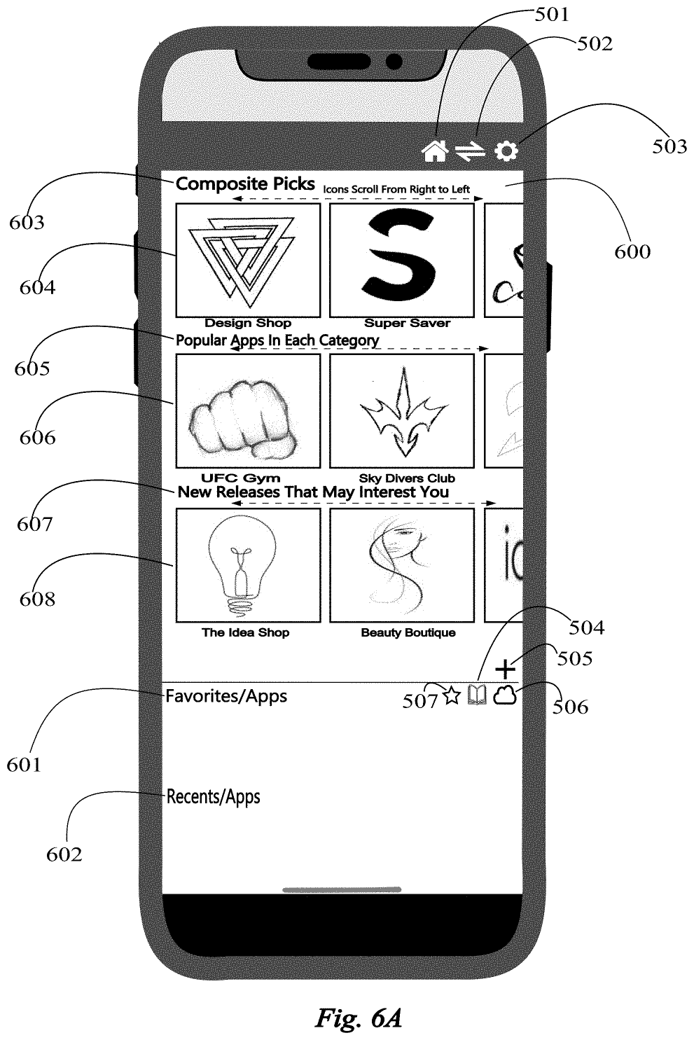

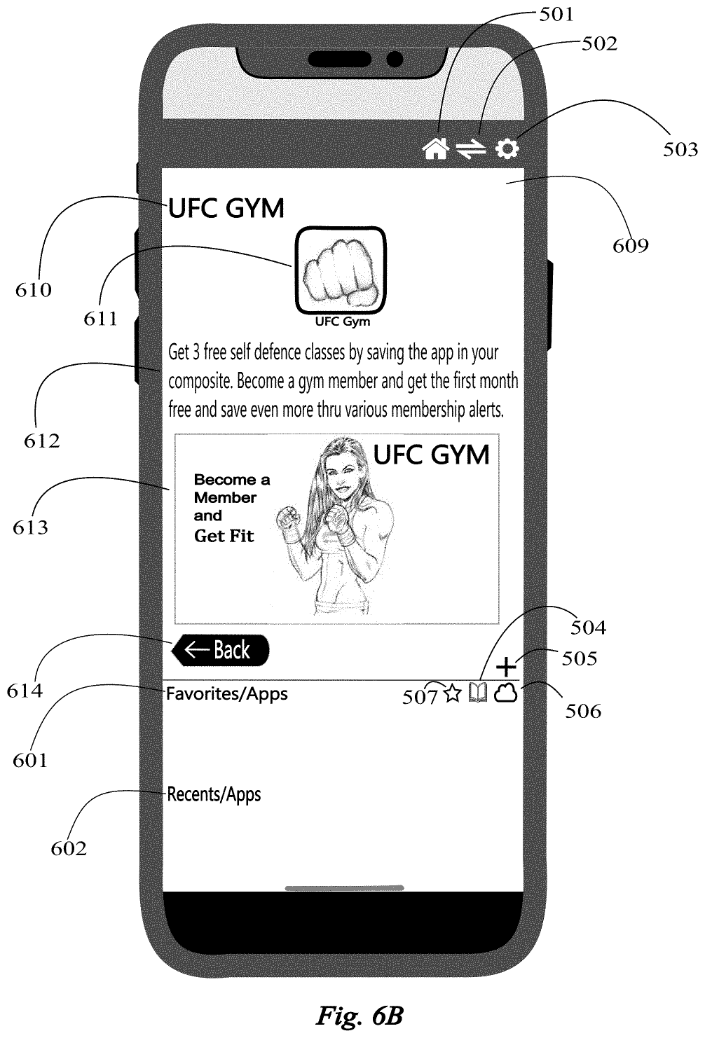

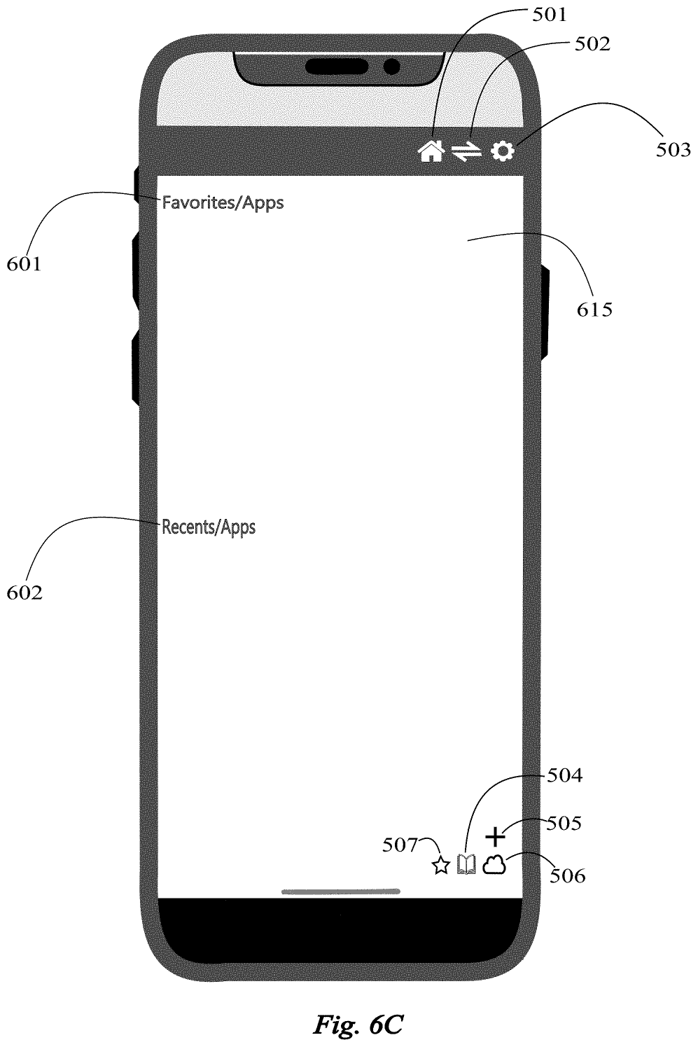

When the end-user navigates to sign-up 300 in block 301 (FIG. 4A) or sign-in 401 in block 402 (FIG. 4B), she may enter the username and password, click OK, and be entered through the system to a welcome screen 600 illustrated as FIG. 6A. On this screen the end-user can access her account, search for applications, any products, services, or businesses online, and perform other functions in FIG. 6A. There may be two distinct classifications of how applications are grouped in the Application Composite's 102 Welcome Screen 600 which may be shown towards the bottom of one of the embodiments.

A Favorites/Apps Grouping 601, may be where saved applications are permanently stored and Recents/Apps Grouping 602, may be where recently visited applications are found but unsaved in the Application Composite 102, according to an embodiment of the present invention.

The Welcome Screen 600 may exhibit several rows of large icon advertisement windows with each row presenting a different heading from the other. In FIG. 6A the top row of advertisement windows 604 may have a heading entitled “Composite Picks” 603, which may be a list of solicitation windows the internal mechanism which may recommend the end-user to open upon signing into the Application Composite 102. The second row of advertisement windows 606 may display a title “Popular Apps in Each Category” 605. This window may show solicitations of applications that may be trending a high volume of traffic with other composite users. And a third row of solicitation windows 608 may display a title above it that reads “New Releases That May Interest You” 607.

The Application Composite 102 may have an internal mechanism that learns the end-user's interests over time. Moreover, this window may not be revealed until after the end-user has spent a considerable amount of time using the Application Composite 102. All the advertisement windows listed in FIG. 6A may comprise scroll features to view them in their entirety.

FIG. 6A also show one of the icon windows, UFC Gym being selected for review from the row of solicitations 606. FIG. 6B may further highlight the action performed in FIG. 6A by presenting a demonstration of an advertisement screen 609 which may reveal at the top the name of the application 610 along and the application icon underneath 611. Below the application icon 611 may display an introductory offer 612 with an incentive picture and pitch 613 to save the application 611 for UFC Gym in the end-user's Application Composite 102. The Application Composite 102 may give the end-user two options to save an application.

The first method the end-user may simply be able to drag the application down to the Favorite Apps/Grouping 601 that may be displayed at the bottom of the embodiment and a second method maybe to simply hold the application icon down until a saved confirmation sign appear to the Application Composite 102. Each of the saved applications may be found in the category's sections of the Application Composite 102 by tapping the cloud icon 506 and toggle. A Back Button 614 is also shown in one of the embodiments of the present invention which may enable the end-user to navigate back to the Welcome Screen 600 when desired.

The end-user's Home Screen 615 is demonstrated in FIG. 6C. The illustration in FIG. 6C reveal what a new user's Home Screen 615 will look like upon the initial sign up phase.

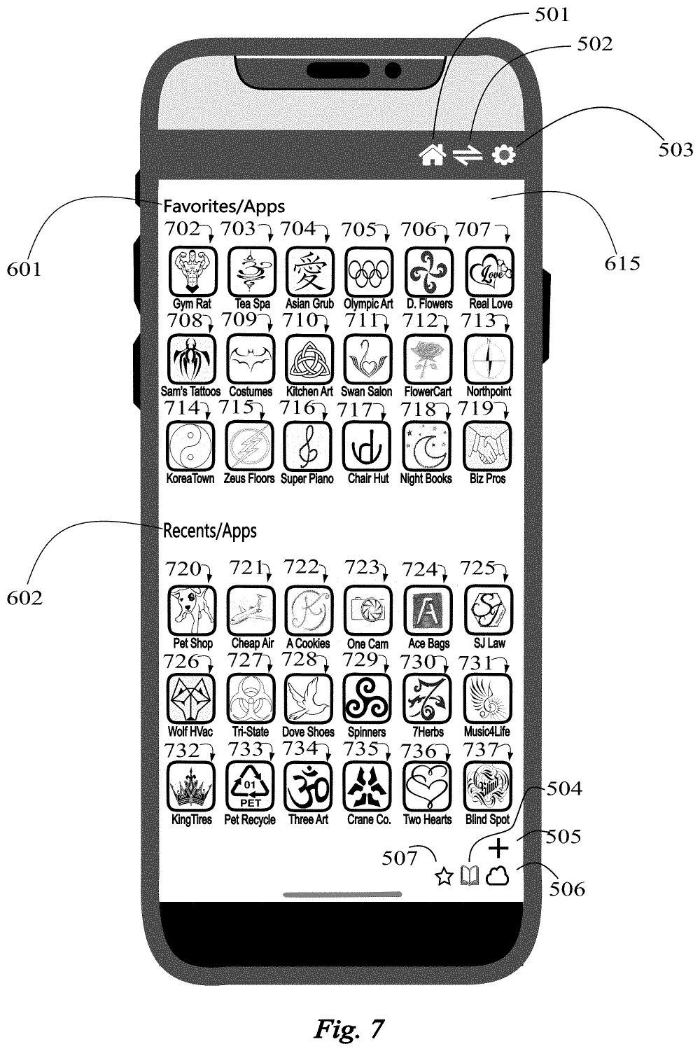

To the contrary of a new end-user's Home Screen 615 shown in FIG. 6C, the illustration in FIG. 7 may reveal an image of what an experienced end-user's Home Screen 615 will look like in the Application Composite 102. There may be two distinct classifications of how applications are grouped on the Home Screen 615 of the Application Composite 102. A Favorites/Apps Grouping 601, may be where saved applications are permanently stored and revealed and Recents/Apps Grouping 602, may be where recently visited applications are found and displayed as unsaved applications in the Application Composite 102, according to an embodiment of the present invention. The Favorites/Apps Grouping 601 shown in FIG. 7 may show numerous saved applications on Home Screen 615. Each of the applications may be saved and displayed under the Favorites/Apps Grouping 601 is named in FIG. 7.

The application titles in the illustration are as follow: Gym Rat 702, Tea Spa 703, Asian Grub 704, Olympic Art 705, D. Flowers 706, Real Love 707, Sam's Tattoos 708, Costumes 709, Kitchen Art 710, Swan Salon 711, FlowerCart 712, Northpoint 713, Korea Town 714, Zeus Floors 715, Super Piano 716, Chair Hut 717, Night Books 718, and Biz Pros 719. All the applications saved in the Favorites/Apps Grouping 601 may comprise a scroll feature to view them in their entirety.

As in the Favorites/Apps Grouping 601, each of the applications may be listed in the Recents/Apps Grouping 602 is named in FIG. 7. Likewise, the application titles in the illustration are as follow: Pet Shop 720, Cheap Air 721, A. Cookies 722, One Cam 723, Ace Bags 724, SJ Law 725, Wolf HVAC 726, Tri-State 727, Dove Shoes 728, Spinners 729, 7Herbs 730, Music4Life 731, KingTires 732, Pet Recycle 733, Three Art 734, Crane Co. 735, Two Hearts 736, and Blind Spot 737. The seven primary navigation toggles presented in FIG. 5 may also be on display in FIG. 7 demonstrating an illustration of a fully interactive home screen 615. The House Symbol 501, the Reverse Arrows Symbol 502, the Gear Symbol 503, the Book Symbol 504, the Plus Symbol 505, the Cloud Symbol 506, and the Star Symbol 507, with each of their distinctive characteristics described in detail in FIG. 500, may be available at the end-user's discretion in FIG. 7 as examples in this embodiment. Furthermore, FIG. 7 demonstrates a variation of what a comprehensive home screen may appear as for end-user in one embodiment of the present invention. All the applications listed in the Recents/Apps Grouping 602 may comprise a scroll feature to view them in their entirety.

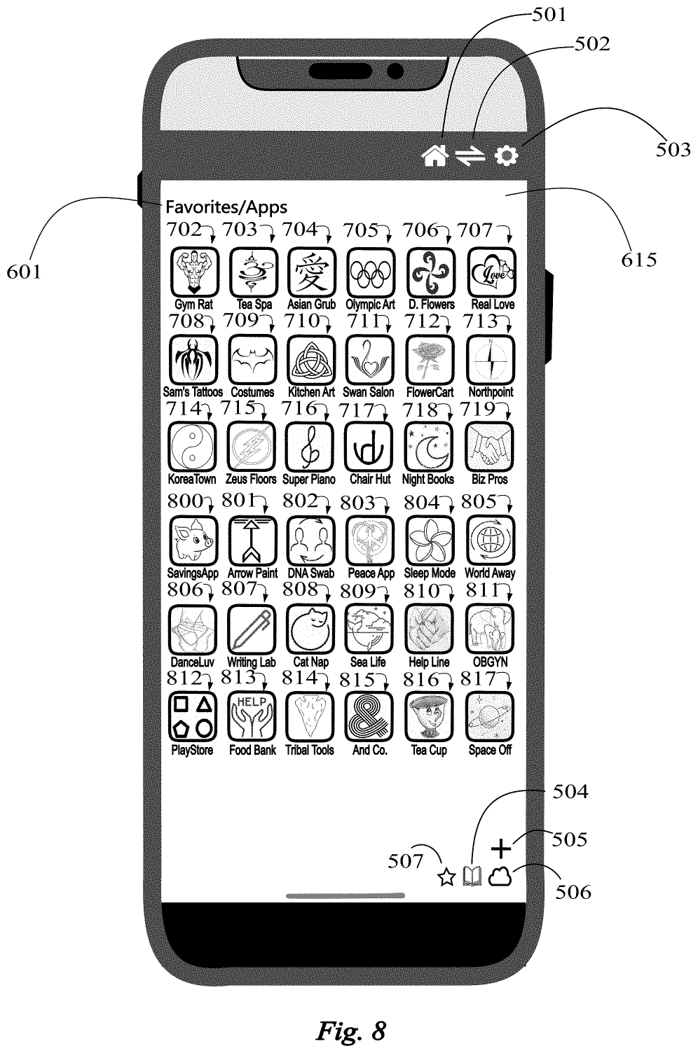

FIG. 8 reveals in one embodiment of the present invention an end-user's home screen 615 may illustrate an entire catalog of the end-user's favorite applications entered under the Favorites/Apps Grouping 601. While on the Home Screen 615, the end-user may be also simply double tap the Star Symbol 507 and recall a complete catalog of saved applications stored in the end-user's Application Composite 102 at the end-user's discretion the entire favorites catalog may be exhibited in alphabetical, categorical, or chorological in the order in which may be augmented by tapping the Gear Symbol 503 for settings and the Knob Symbol 510 for “Preferences”.

The embodiment in FIG. 8 likewise may reveal numerous saved applications displayed under the Favorites/Apps Grouping 601 in FIG. 7 also shown in FIG. 8. However the embodiment in FIG. 8 demonstrates an extended list of saved applications under the Favorites/Apps Grouping 601; a total of 36 in all. The list of applications are as follow: Gym Rat 702, Tea Spa 703, Asian Grub 704, Olympic Art 705, D. Flowers 706, Real Love 707, Sam's Tattoos 708, Costumes 709, Kitchen Art 710, Swan Salon 711, FlowerCart 712, Northpoint 713, Korea Town 714, Zeus Floors 715, Super Piano 716, Chair Hut 717, Night Books 718, Biz Pros 719, SavingsApp, Arrow Paint 801, DNA Swab 802, Peace App 803, Sleep Mode 804, World Away 805, DanceLuv 806, Writing Lab 807, Cat Nap 808, Sea Life 809, Help Line 810, OBGYN 811, PlayStore 812, Food Bank 813, Tribal Tools 814, And Co. 815, Tea Cup, and Space Off 817. This list may be truncated or may be extended differing on the number of applications the end-user show stored in the Application Composite 102. A longer list may require the end-user a scroll feature to reveal them all according to an embodiment of the present invention.

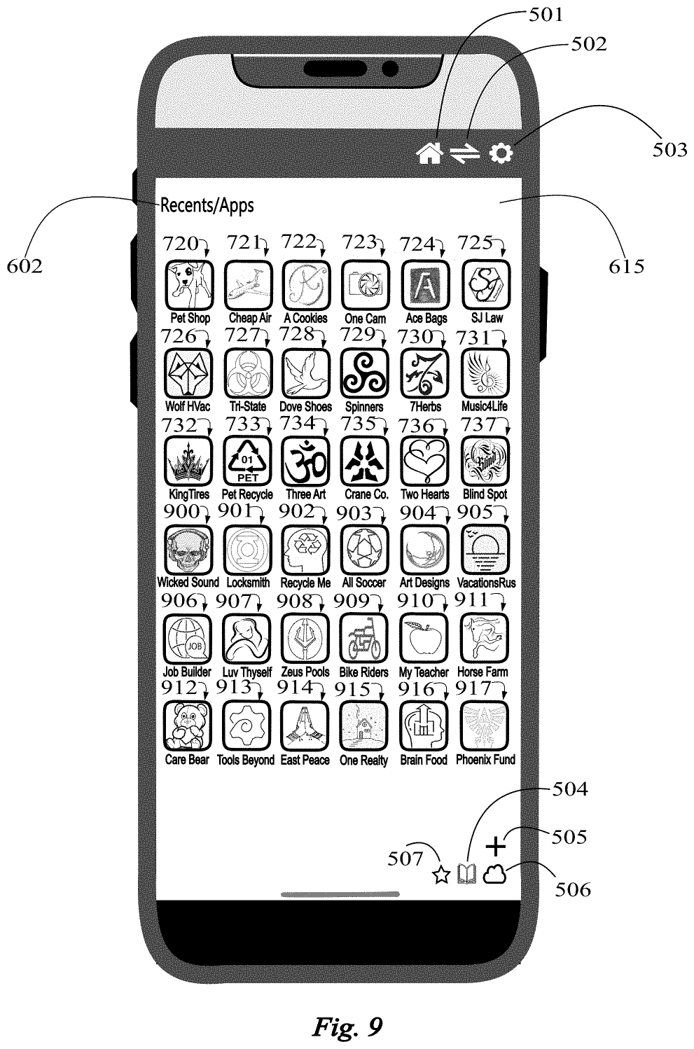

FIG. 9 reveals in one embodiment of the present invention an end-user's Home Screen 615 illustrating entire catalog of the end-user's recently visited applications shown under the Recents/Apps Grouping 602. While on the Home Screen 615, the end-user may simply double tap the Book Symbol 504 and recall a comlete catalog of recently visited applications listed in the end-user's Application Composite 102. At the end-user's descretion the entire recents catalog may be exhibited in alphabetical, categorical, or chrologically in the order in which they were visited by tapping the Gear Symbol 503 for settings and the Knob Symbol 510 for “Preferences” according to one embodiment of the present invention.

The embodiment in FIG. 8 likewise reveal numerous saved applications displayed under the Favorites/Apps Grouping 601 in FIG. 7 also shown in FIG. 8.

The various recently visited applications may be displayed under the Recents/Apps Grouping 602 in FIG. 7 which may also exhibited in FIG. 9. However, FIG. 9 demostrates an extended list of recently visited applications that may be shown under Recents/Apps Grouping 602; in one embodiment of the present invention. The list of applications are as follow: Pet Shop 720, Cheap Air 721, A. Cookies 722, One Cam 723, Ace Bags 724, SJ Law 725, Wolf HVAC 726, Tri-State 727, Dove Shoes 728, Spinners 729, 7Herbs 730, Music4Life 731, KingTires 732, Pet Recycle 733, Three Art 734, Crane Co. 735, Two Hearts 736, Blind Spot 737, Wicked Sound 900, Locksmith 901, Recycle Me 902, All Soccer 903, Art Designs 904, VacationsRus 905, Job Builder 906, Luv Thyself 907, Zeus Pools 908, Bike Riders 909, My Teacher 910, Horse Farm 911, Care Bear 912, Tools Beyond 913, East Peace 914, One Realty 915, Brain Food 916, and Phoenix Fund 917. This list may be truncated or extended differing on the number of applications the end-user show recently visited in the Application Composite 102. A longer list may require the embodiment of the present invention be comprised with a scroll feature to reveal them all.

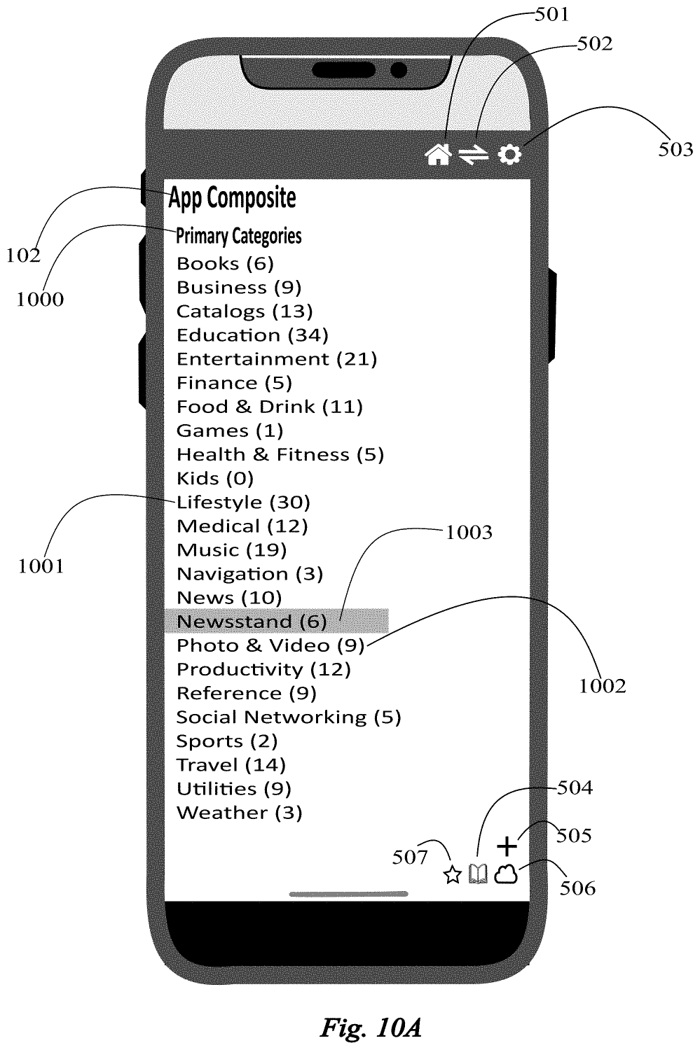

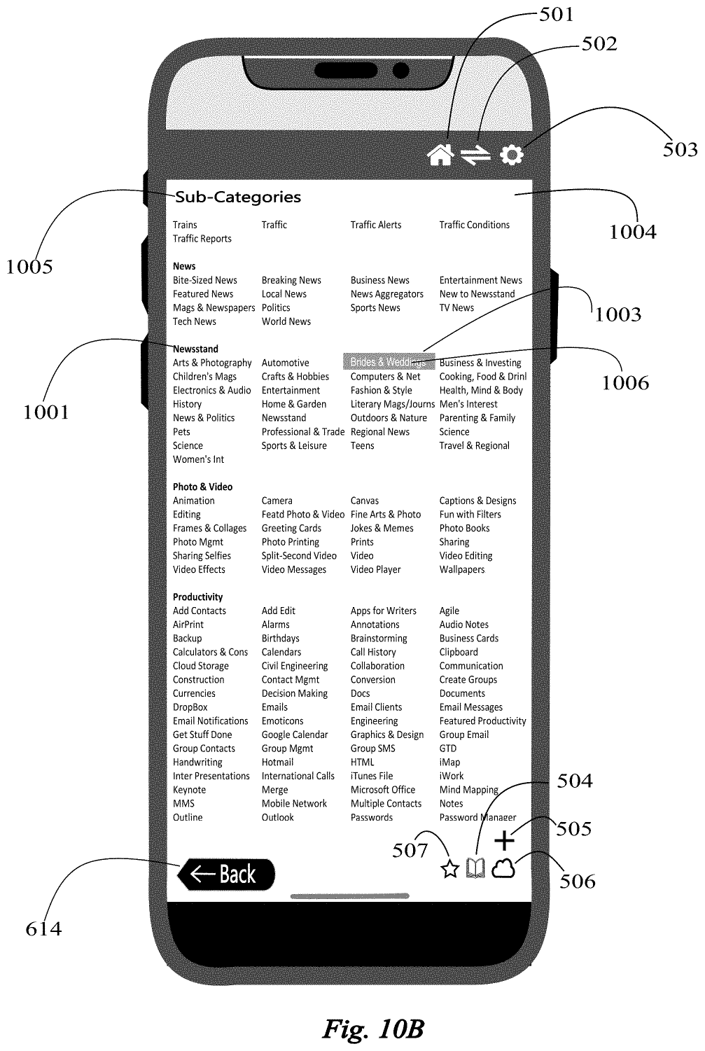

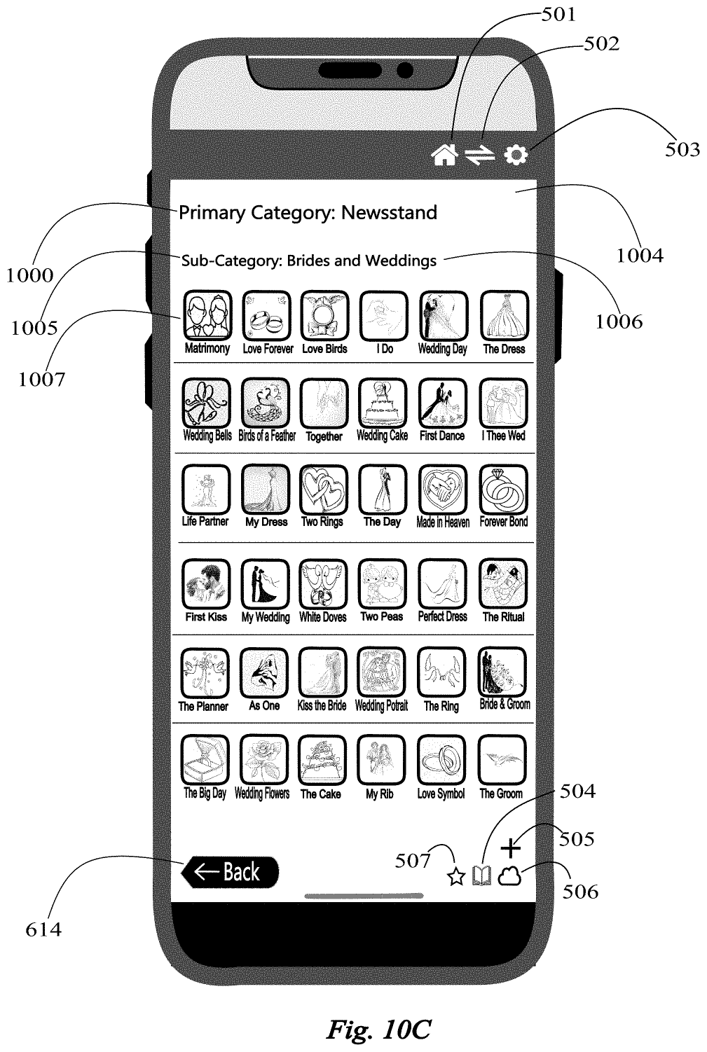

The Application Composite 102 may well have at minimal 24 Primary Categories in which an application can be classified under as shown in FIG. 10A. The Application Composite 102 may display the Primary Categories 1000 with a listing of the Primary Category titles 1001 below as provided in the embodiment as: Books, Business, Catalogs, Education, Entertainment, Finance, Food & Drink, Games, Health & Fitness, Kids, Lifestyle, Medical, Music, Navigation, News, Newsstand, Photo & Video, Productivity, Reference, Social Networking, Sports, Travel, Utilities, and Weather. The illustration in FIG. 10A also may show the list of Primary Category titles 1001 with a number in parenthesis beside the category name is a (number) 1002 detailing the amount of applications each classification has stored under it. The cursor 1003 may highlight the category the end-user may wish to open. The seven primary navigation toggles presented in FIG. 5 or variations thereof may also be on display in FIG. 10A according to an embodiment of the present invention.

A Sub-Category Screen 1004 is displayed in FIG. 10B. At the top may exhibit the heading Sub-Categories 1005. Below the heading Sub-Categories 1005 may be comprise a scrolling feature possibly view all 24 Primary Categories titles 1001 with numerous Sub-Category titles 1006 appearing underneath. The Sub-Categories titles 1006 are an extensive listing and catalog ranging across many fields of interest, subject matter, and variations of genres within the 24 Primary Categories titles 1001.

The Sub-Category titles 1006 under the Primary Category 1000, Books may display these titles: Bedtime Stories, Celebrate the Arts, Children & Teens, Comics, Comics & Graphics Novels, Featured Books, Poetry, Religion & Spirituality, and Romance.

The Sub-Category titles 1006 under the Primary Category 1000, Business may display these titles: Accountant, Accounting, Accounting Software, Administrator, Analytics, Annual Reports, Architects, Auction, Billing, Branding, Brochures, Business Cards, Business Ideas, Business Networking, Business Plan, Career, Cargo, Conferences, Container, Contract Management, Communication, Customer Management, Dashboards, Deliveries, Dispatch, Distributors, Documents, Email Marketing, Enterprise, Enterprise, Server, Engineering, Featured Business, Fleet, Freight, Get Stuff Done, Grow Your Career, Home Buyers, HR, IBM, Industry, Investments, Investors, Invoices, Jobs, Law, Logo, Machinery, Managers, Manufacturing, Marketplace, Marketing, Merchant, Mileage, Mining, MLS, Mobility, Mobile Marketing, Oil, Oracle, Payroll, Personnel, PDF Reader, Point of Sale, Portfolio, Presentations, Printing, Project, Management, Property Management, Property Searches, QR Codes, Real Estate, Receipts, Recruitment, Rent, Reporting, Resellers, Resume, Retirement, Sales, Salesforce, Sales Orders, SAP, Scanning, Sellers, SEO, Share Documents, SharePoint, Shipping, Small Business, Start Your Business, Steel, Stock Market, Success Stories, Suppliers, Supply Chain, Tax Calculators, Taxes, Tax Preparation, Tax Rates, Tax Returns, Timesheet, Trading, Wealth Management, Warehouse, Wholesalers, and Work Orders.

The Sub-Category titles 1006 under the Primary Category 1000, Catalogs may display titles such as: Architects, Automotive, Consumer Products, Dresses, Deals & Rewards, Fashion, Featured Catalogs, Home & Office, Interior Designers, Jewelry, Luxury Goods, Manufacturing, Promotional, Shopping, and Showroom.

The Sub-Category titles 1006 under the Primary Category 1000, Education may display these titles: AAC, Acids, Addition, ADHD, Administrators, Algebra, Algebraic Equations, Alphabets, Alternative Communication, AP, AP Biology, Aphasia, American Sign Language, Anatomy, Angles, Area Calculators, Arithmetic, Art & Music, Assessment, Assignments, Astronomy, Assignments, Auditory, Athletics, Athletic Events, Athletic Schedules, Attendance, Autism, Autism Spectrum Development, Autism Spectrum, Basic Addition, Basic Algebra, Basic Chemistry, Basic Operations, Basic Shapes, Behavior, Biochemistry, Biology, Biology Exam, Bonding, Bullying, Calculators, Calculus, Calendars, Campus, Directory, Campus Events, Campus Tour, Career & Professional, Certification, Cells, Cell Biology, Chemical Elements, Chemistry, Chemistry Exam, Classroom, Classroom Management, Cognitive Blackboard, College Athletics, College Calculus, College & University, College of Engineering, Coefficient, Conferences, Constellations, Common Core, Common Core Math, Common Core Studies, Common Core Stands, Common Multiple, Comparing Fractions, Complex Numbers, Compounds, Computers & Technology, Computer Science, Constants, Counting, Curriculum, Curriculum Decimals, Decimals, Denominator, Differential Equations, Differentiation, Digits, Disabilities, Dividing Factors, Diving Fractions, Division, Division Tables, Dolch, Drills, Dyslexia, Ecology, Educational Games, Eighth Grade, Elementary School, Elementary School Teachers, Educational Math, Emotions, Engineering, Engineering Students, English Letters, Equations, Equation Calculator, Equivalent Fractions, Exponents, Expressions, Facial Expressions, Factoring, Factors, Featured Education, First Grade, First Words, Fluency, Formulas, Fourth Grade, Fractions, Fraction Calculator, Geology, General Chemistry, Genetics, Geometric, Geometric Shapes, Geometry, Grammar, Graphing, Happiness, High School, Homework, Homework Projects, Identities, Improper Fractions, Incidents, Inequalities, Integrals, Interactive Alphabet, Interactive Campus Map, Interventions, Interview, Kids Math, Kindergarten, Language Arts, Language Development, Latest Headlines, Learning English, Learn ABC, Learn Colors, Learning Numbers, Learn Shapes, Learning Times Tables, Lectures, Lesson, Lesson Plans, Library Catalog, Life Sciences, Linear, Linear Equations, Literacy, Logarithms, Long Division, Math, Math Exercises, Math Problems, Math Questions, Math Quiz, Math Teacher, Math Tutor, Math Worksheets, Matrices, MCAT, Memorization, Mental Arithmetic, Mental Calculations, Mental Health, Mental Math, Microbiology, Middle School, Middle School Math, Mixed Numbers, Modeling, Molecular, Multiplication, Multiple Choice, Workshops, Number Lines, Observations, Operators, Order of Operations, Organic Chemistry, Organisms, Pathologist, Psychology, Psychology Exam, Practice Questions, Practice Spelling, Practice Questions, Probability, Professional Development, Probability, Perimeter, Polygons, Probability, Pythagorean Theorem, Prime Numbers, Phonics, Practice Math, Practice Math, Planets, Pathologist, Picture Cards, Physiology, Probability, Preschool & Kindergarten, Polynomials, Pre-Algebra, Practice Addition, Prime Factorization, Quadratic Equations, Reactions, Reading Skills, Rectangles, Religion & Spirituality, Remainders, Roots, Rosters, SAT, SAT Math, School Age, School Children, School Districts, Science, Science Research, School Math, Self Esteem, Sequences, Seventh Grade, Sight Words, Sign Language, Simply Fractions, Sixth Grade, Slope, Social Sciences, Square Roots, Special Education, Species, Speech Therapy, Spelling, Sports News, Social & EMP Learning, Solids, Staff Directory, Standards, Subtraction, Teachers, Teaching, Teaching Tool, Test Prep, Textbooks, Training Courses, Trigonometric Functions, Trigonometry, Unit Circle, Universities, Variables, Vectors, Verbal, Visual, Visual Schedules, Vocabulary, Whole Numbers, Writing Letters, Writing Alphabet, Word Problems, Worksheets, Workshops, and World Languages.

The Sub-Category titles 1006 under the Primary Category 1000, Entertainment may consist of these titles: Animals, Animal Sounds, Anime, Augmented Reality, Broadway, Breeds, Cats, Cinema, Comedy, Comics, Concerts, Cows, Dance, Elf, Featured Entertainment, Festival, Films, Funny Animals, Get Your Tickets, Giraffe, Going to the Movies, Holidays, Horror, Horses, Insects, Kitten, Lion, Live TV, Lottery, Novelty, Manga, Mouse, Movies, Music, Musicals, Opera, Tiger, TV Time, Panda, Performance Arts, Pets, Pictures, Puppy, Sci-Fi, Strips, Superhero, Television, TV Channels, TV Guide, TV Series, TV Shows, and Zoo.

The Sub-Category titles 1006 under the Primary Category 1000, Finance may display titles like: Accounting, Allowance, Banking, Bills, Calculators, Car Insurance, Car Loan, Credit Cards, Currency Converter, Currencies, Featured Finance, Financial Planning, Home Insurance, Home Loan, Health Insurance, Interest Rates, Insurance, Insurance Companies, Insurance Quotes, Investments, Loan Calculator, Loans, Money Management, Mortgage Calculator, Mortgage Insurance, Personal Finance, Personal Loans, Price Calculator, Receipts, Salary, Stocks & Investment, Student Loans, Taxes, Tip Calculator, and Travel Insurance.

The Sub-Category titles 1006 under the Primary Category 1000, Food and Drinks may display these titles: Bakery, Bars & Pubs, Beer, Beverages, Chefs, Cocktails, Coffees, Cooking, Deals & Loyalty, Desserts, Ent Made Easy, Featured Food & Drink, Food & Drink Magazines, Grocery Stores, Healthy Eating, Juices, Meal Planning, Meals, Meat, Ordering & Takeout, Pantry, Pasta, Pizza, Produce, Recipes, Restaurants, Salads, Sandwiches, Shopping & Grocery, Seafood, Shopping Lists, Soups, Spirits, Supermarket, Tea, and Wine.

The Sub-Category titles 1006 under the Primary Category 1000, Games may reveal titles like: Action, Action Adventure, Action Arcade, Adrenaline, Adventure, Arcade, Arcade Platformer, Arcade Shooters, Arcade Style, Archers, Armor, Asteroids, Attacks, Alien, Alien Invaders, Battles, Baseball, Basketball, Backwards, Baccarat, Backgammon, Benchmark Games, Big-Name Games, Bingo, Big-Name Games, Blackjack, Blast, Blaster, Boss Battles, Boss Fights, Bowling, Bow, Boxer, Board, Brain Training, Bridge, Bullets, Business, Card, Casino, Castle, Celebrities, Craps, Cricket, Crosswords, Classic, Classic Arcade, Classic Platformer, Classic Word Search, Combat, Competitive Online Gaming, Cribbage, Cryptograms, Cycling, Defense, Demons, Dice, Dogfight, Double Jump, Dragon, Dungeon, Easy Words, Educational, Empire, Endless Runner, Explosions, Evil, Euchre, Family, Fantasy, Farkle, Featured Action, Fighter Pilots, Fighter, Fighter Jets, Fighting, Fishing, Flight, Foes, Football, Game Center, Game Night, Geography, Gorgeous Games, Goblins, Golf, Hangman, Hunting, History, Hockey, Home Planet, Hordes, Invasion, It's Your Turn to Play, Jet, Joystick, Karate, Keno, Kingdom, Kung Fu, Lands, Lasers, Logic, Logos, Long Words, Loot, Ludo, Jumping, Martial Arts, Match, Meteorites, Memory, Memory Match, Meteors, Military, Motocross & BMX, Movies, Multiplayer, Music, Number, Olympic Events, Orbit, Ores, Outer Space, Pachinko, Pilot, Pixel, Planes, Planet Earth, Planets, Platformer, Poker, Pop Culture, Popular Puzzlers, Puzzle, Puzzle Platformer, Puzzler, Princess, Quests, Quick-Fix Games, Racing, Retro Arcade, Retro Games, Retro Style, Robots, Rocket, Role Playing, Roller, Roulette, Rugby Rummy, Running, Sci-Fi, Scrambles, Shield, Shields, Shooters, Simulation, Slot Machines, Soccer, Solar System, Solitaire, Space Fighters, Space Shooter, Spaceship, Space Station, Spades, Spelling, Spells, Spikes, Sports, Strategy, Strategy Games, Street Fighter, Sword, Tanks, Television, Trivia, 2D Platformer, UFO, Under Attack, Universe, Vehicles, Video Game, Virtual Pet, Warfare, Warrior, Warriors, Weapon, Word, Word Games, Word Search, and Yahtzee.

The Sub-Category titles 1006 under the Primary Category 1000, Health & Fitness may display these titles: Abs, Acupuncture, Acupuncture Points, Aerobics, Alternative Medicine, Ambiance, Ambient Sounds, Aromatherapy, Asanas, Athletes, Baby Names, Barre, Bench Press, Biceps, Birth, Birth Control, Black Belt, Body Fat, Body Mass, Body Weight, Body Workouts, Bodybuilding, Bodyweight, Boxing, Brain Waves, Breastfeeding, Breathing, Breathing Exercises, Breathing Techs, Build Muscle, Burned Calories, Calorie Counter, Calories Tracker, Cardio, Cardio Exercises, Cardio Workouts, Cardiovascular, Certified Personal Trainer, Chest, Chiropractors, Circuit Training, Class Schedules, Coaches, Conditioning, Core Strength, Crickets, Cardio, Cross Fit, Cues, Custom Workouts, Cycling, Daily Calories, Daily Workouts, Date Calendar, Deep Relaxation, Deep Sleep, Diabetes, Effective Workouts, Endurance, Essential Oils, Exercise Routines, Fat Burning, Fat Loss, Fertility, Fitness & Exercise, Fitness Classes, Fitness Exercises, Fitness Goals, Fitness Tracking, Fitness Trainers, 5 k, Flexibility, Flow Yoga, Food Database, Food Diary, Foods, Forest, Free Weights, Full Body, Get in Shape, Group Fitness, Guided Meditations, Gym, Gym Memberships, Habits, Health & Fitness, Healthy Living, Healthy Pregnancy, Heart Rate Monitor, High Intensity, Hilt, Home Remedies, Hypnosis Audio, Hypnotherapy, Interval, Interval Timer, Interval Training, Karate, Kettlebell, Kickboxing, Kundalini, Learn Yoga, Legs, Lifting, Lose Weight, Lower Body, Marathon, Martial Arts, Martial Arts School, Massage, Massage Techniques, Massage Therapy, Mat, Medical, Meditation, Meditation Music, Melodies, Metabolism, Mind Body, Mindfulness, Mindfulness Meditation, Mindfulness Practice, Minute Workout, Mixed Martial Arts, Motivation, Muscle Groups, Muscles, Natural, Nights, No Equipment, Nutrition, Nutritionists, Office Yoga, Oral Health, Pain, Periods, Personal Trainer, Personal Training, Physical Activity, Physio, Physiotherapy, Pilates, Pilates Classes, Poses, Postures, Pregnancy, Prenatal, Protein, Protocol, Rain, Relax & Meditation, Relaxing Music, Relaxing Sounds, Rep Max, Repetitions, Resistance, Round Timer, Rounds, Routines, Runners, Sanskrit, Self Defense, Sequences, Sleep Aid, Sleep Quality, Soothing, Soothing Sounds, Soothing Voice, Sounds of Nature, Spa Services, Sprint, Stopwatch, Strength Training, Stretches, Studios, Subliminal, Tabata, Taekwondo, Tai, Tai Chi, Target Weight, Technique, Therapy, Timers, Toning, Trainer, Trainers, Training Programs, Treadmill, Treatments, Upper Body, Vinyasa, Vision, Waist, Wake, Waves, Weight Loss, Weight Loss Goals, Weight Management, Weight Tracker, Weight Training, Weightlifting, Wellbeing, Wellness, Wellness Center, WOD, Workout Data, Workout Log, Workout Plans, Workout Programs, Workout Sessions, Workout Timer, Workout Tracker, Workout Videos, Workouts, Yoga, Yoga Classes, Yoga Instructor, Yoga Postures, Yoga Practice, Yoga Sessions, Yoga Studios, Yoga Teachers, Yoga Videos, Yogis, Zumba.

The Sub-Category titles 1006 under the Primary Category 1000, Kids may display a list of applications by age group like: All Kids, Kids 5 & Under, Kids 6-8, and Kids 9-11.

The Sub-Category titles 1006 under the Primary Category 1000, Lifestyle may reveal titles similar to: Anniversary, Arts & Culture, Arts & Crafts, Automotive, Beauty & Grooming, Birth Chart, Babies, Baby Sleep, Baby Monitor, Baby Names, Baby Shower, Birth, Birthdays, Bride, Beads, Boutique, Bracelets, Cards & Stationary, Collections, Compatibility, Daily Fortune, Date of Birth, Destiny, DIY & Crafting, Daily Horoscope, Daily Predictions, Daily Readings, Deck, Designers, Diamond, Diamond Rings, Earrings, Engagement Rings, Environment & Community, Family, Fashion, Favorite Names, Featured Lifestyle, Feng Shui, Fine Jewelry, For the Weekend, Fortune, Fortune Teller, Free Daily Horoscope, Friends Birthdays, Gender, Growth, Guests, Guidance, Happiness & Wellbeing, Home, Horoscopes & Astrology, Interpretations, Jewelry, Jewelry Design, Journals & Diaries, Life, Love Horoscopes, Love, Lunar, Luxury, Memories, Milestones, Moon, Necklaces, Noise, Numerology, Oracle, Parenting, Parenting Tips, Pregnancy, Prayer Beads, Planets, Predictions, Personality, Personality Traits, Pets, Positions, Psychic, Personalization, Readings, Real Estate, Relationships, Relax & Meditation, Religion & Spirituality, Rings, Seasons & Holidays, Shopping, Signs, Silver, Special Occasions, Strengths, Tarot Cards, Tarot Deck, Tarot Readings, Tarot, Vedic, Week by Week, Wedding, Weddings & Occasions, Wedding Anniversary, Wedding Day, Wedding Party, Wedding Rings, White, WiFi Network, Wisdom, Upcoming Birthdays, Yearly Horoscope, Zodiac, and Zodiac Signs.

The Sub-Category titles 1006 under the Primary Category 1000, Medical may display fields of interest like: Abdomen, Aesthetic, American Society, Anatomy & Physiology, Anatomical, Anatomical Models, Anesthesia, Appearance, Augmentation, Bone, Breast, Cardiac, Cardiology, Cataract, Cells, Clinical, Consultation, Cosmetic Surgery, Dental, Dermatology, Diagnosis, Digestive, Disease, Diseases, Drug, Drug Interactions, Drug Reference, Facial Plastic, FACS, Featured Medical, General Surgery, Health Care, Healthcare Pros, Human Anatomy, Human Body, Implants, Interactions, Insertion, Kidney, Knee, Laser, Liver, Liver Disease, Medical Procedures, Medical Students, Muscles, Neck, Nerves, Nervous System, Nurses, Operative, Ophthalmology, Oral, Orthopedic, Orthopedics, Orthopedic Surgeons, Patient, Patient Education, Pathology, Pelvis, Pharmacology, Physician, Physicians, Pill, Plastic Surgery, Prescription, Prescription Drugs, Procedure, Refill, Rejuvenation, Reproductive, Respiratory, Side Effects, Skeleton, Skeleton System, Skin, Skull, Specialties, Spine, Surgery, Surgical Procedures, Surgical Techniques, Symptoms, Tissue, 3D Views, Treatment Journal, Trauma, and Treatments.

The Sub-Category titles 1006 under the Primary Category 1000, Music may display these titles: Amp, Apps for Learning Music, Band In Your Head, Bass, Chords, DAW, DJs, Drums, Ear, Featured Music, Fingering, Flute, Guitar, Instruments, Learning & Tools, Live Music, Lyrics, Melody, Metronome, MIDI, Musical Apps for Kids, Music Discovery, Music Players, Music Production, Music Theory, Octaves, Percussion, Piano, Radio, Ringtones, Rhythm, Samples, Saxophone, Scales, Sequencer, Sheet Music, Trumpet, Tuner, Videos, Violin, Vocals, and Xylophone.

The Sub-Category titles 1006 under the Primary Category 1000, Navigation may comprise of these titles: Accidents, Aeronautical, Altitude, Altimeter, Banks, Bearing, Buses, Cams, Car Services & Taxis, Coffee Shops, Compass, Cycling, Driving Directions, Elevation, Featured Navigation, Ferry, GPS Location, GPS Tracking, GPS Coordinates, Gas Stations, Hiking & Camping, Hotspots, Malls, Maps, Marine, Navigation Utilities, Nearby Restaurants, On Deck, Outdoors, Parks, Parking, Points of Interest, Public Trans, Toilets, Routes & Directions, Route Planner, Roads, Speedometer, Street View, Trails, Trains, Traffic, Traffic Alerts, Traffic Conditions, and Traffic Reports.

The Sub-Category titles 1006 under the Primary Category 1000, News may display these titles: Bite-Sized News, Breaking News, Business News, Entertainment News, Featured News, Local News, News Aggregators, New to Newsstand, Mags & Newspapers, Politics, Sports News, TV News, Tech News, and World News.

The Sub-Category titles 1006 under the Primary Category 1000, Newsstand may consist of numerous titles in the embodiment of the present invention such as: Arts & Photography, Automotive, Brides & Weddings, Business & Investing, Children's Magazines, Crafts & Hobbies, Computers & Internet, Cooking, Food & Drink, Electronics & Audio, Entertainment, Fashion & Style, Health, Mind & Body, History, Home & Garden, Literary Magazines and Journals, Men's Interest, News & Politics, Newsstand, Outdoors & Nature, Parenting & Family, Pets, Professional & Trade, Regional News, Science, Sports & Leisure, Teens, Travel & Regional, and Women's Interest.

The Sub-Category titles 1006 under the Primary Category 1000, Photo and Video may consist of a variation of these titles: Animation, Cam, Canvas, Captions & Designs, Editing, Featured Photo & Video, Fine Arts & Photo, Fun with Filters, Frames & Collages, Greeting Cards, Jokes & Memes, Photo Books, Photo Management, Photo Printing, Prints, Sharing, Sharing Selfies, Split-Second Video, Video, Video Editing, Video Effects, Video Messages, Video Player, and Wallpapers.

The Sub-Category titles 1006 under the Primary Category 1000, Productivity may display titles such as: Add Contacts, Add Edit, Apps for Writers, Agile, AirPrint, Alarms, Annotations, Audio Notes, Backup, Birthdays, Brainstorming, Business Cards, Calculators & Converts, Calendars, Call History, Clipboard, Cloud Storage, Civil Engineering, Collaboration, Communication, Construction, Contact Management, Conversion, Create Groups, Currencies, Decision Making, Docs, Documents, DropBox, Emails, Email Clients, Email Messages, Email Notifications, Emoticons, Engineering, Featured Productivity, Get Stuff Done, Google Calendar, Graphics & Design, Group Email, Group Contacts, Group Management, Group SMS, GTD, Handwriting, Hotmail, HTML, iMap, Inter Presentations, International Calls, iTunes File, iWork, Keynote, Merge, Microsoft Office, Mind Mapping, MMS, Mobile Network, Multiple Contacts, Notes, Outline, Outlook, Passwords, Password Manager, PDF Reader, Phone System, Plain Text, Pomodoro, PowerPoint, Presentations, Project Management, Printer, Procrastination, QR Codes, Quick Notes, Reporting, RPN, Save Contact, Scientific Calculator, Security, Sender, Send Emails, Send SMS, Share Files, Shopping Lists, SIP, Slides, SMS Email, Software Engineering, Speeches, Spreadsheet, Stopwatch, Storage, Sticky Notes, Synchronization, Take Notes, Task Management, Template, Text Editor, Time Management, Time Tracker, Timers, Timesheet, Time Tracking, To-do List, Typing, Unit Converter, VoIP, VoIP Calls, VoIP Phone, VoIP Service, Whiteboard, and Yahoo.

The Sub-Category titles 1006 under the Primary Category 1000, Reference may reveal a listing of these titles: Abbreviations, Aircraft, Apps for Writers, Arabic, Armed Forces, Astronomy, Atlas, Aviation, Biology, Chemistry, Computer Science, Civil War, Danish, Designers, Dictionary & Thesaurus, Encyclopedias, Engineering, Events, Featured Reference, Flags, Formulas, Game Tips, Genealogy, Geometry, Government, Hebrew, Hiking & Camping, Hindi, Idioms, Indonesian, Language & Translation, Japanese Language, Latin, Legal, Manuals, Marine, Math, Medical Dictionary, Military, Navy, Night Sky, Outdoors & Nature, Poetry, Psychology, Religion & Spirituality, Science, Slang, Synonyms, Sign Language, Swedish, Trivia, and Turkish.

The Sub-Category titles 1006 under the Primary Category 1000, Social Networking may display the titles: Blogging, Calling & VoIP, Collaborating, Dating & Relationships, Emoji & Emoticons, Events, Featured Social Networking, Forums, Grow Your Career, Jokes & Memes, Messaging, Picture-Perfect Posts, and Polling & Voting.

The Sub-Category titles 1006 under the Primary Category 1000, Sports may list titles such as these: Aikido, Archery, Auto Racing, Baseball, Basketball, Boating, Bowling, BMX, BJJ, Brazilian, Chokes, Climbing, Cricket, Cycling, Dojo, Extreme Sports, Fantasy Sports, Featured Sports, Fighters, Fights, Fishing, Football, Get Your Tickets, Gold, Gracie, Grappling, Guard, Gymnastics, Hockey, Hunting, Jiu Jitsu, Judo, Karate, Kata, Kickboxing, Kung Fu, Listen & Watch, Martial Arts, Mixed Martial Arts, News & Scores, Olympics, Running, Rowing, Sailing, Soccer, Skateboarding, Snow Sports, Sports Games, Submissions, Surfing, Sweep, Taekwondo, and Wing Chun.

The Sub-Category titles 1006 under the Primary Category 1000, Travel may reveal these titles: Accommodations, Airports, Air Travel, Audio Tours, Beach Resort, Beaches, Bookings, Camping, Car Service, Croatian, Cruise, Cruises & Boating, Currency Converter, Czech, Danish, Dutch, Excursions, Featured Travel, Flights, Forests, Gardens, Gas Stations, Historical Sites, Hiking, Hostels, Hotel Booking, Indonesian, Islands, Korean, Language & Translation, Limousines, Luxury Hotels, Mandarin, Monuments, Motels, Mountain Biking, Mountain Resort, Mountains, National Park, Packing, Parks, Points of Interest, Polish, Portuguese, Postcard, Public Trans Outdoors, Rentals, Resorts, Road Trip, Ski Resorts, Skiing, Spa, Swedish, Taxis, Taxi Booking, Thai Language, The Great Outdoors, Tip Calculator, Tours & Guides, Tours, Travel Assistance, Travel Survival Kit, Travel Utilities & Tools, Turkish, Virtual Tours, Villas, Walt Disney, World Clock.

The Sub-Category titles 1006 under the Primary Category 1000, Utilities may display the titles: Alarms & Clocks, Calculators & Converters, Currencies, Communication, Countdown, Developer Utilities & Tools, Emergency Services, Featured Utilities, File Management, Flashlights, Fonts, Gas, Location Services, Networking, Power Management, QR Codes, RPN, Scientific Calculator, Security, Sleep Timer, Stopwatch, Tip Calculator, Unit Calculator, Wallpapers, and Web Browsing.

The Sub-Category titles 1006 under the Primary Category 1000, Weather may display in the embodiment of the present invention titles like: Air Conditions, Air Quality, Aviation, Cloud Cover, Earthquakes, Featured Weather, Forecasts, Hurricane, Lightning Strikes, Moon Phases, NOAA, NOWrad, NWS, Precipitation, Radar, Radar & Satellite, Rainfall, Radar, Severe Weather, Snow & Skiing, Snowfall, Sun & Moon, Sunrise, Surfing, Storms, Temperature, The Great Outdoors, Thermometer, Tides, Tide Tables, UV, Warnings, Weather Maps, Webcams, Winds, and Wind Speed.

All the interests listed under the Sub-Category titles 1006 directory may comprise a scroll feature to view them all in their entirety. FIG. 10B also demonstrate the Sub-Category title 1006 “Brides and Weddings” highlighted with a cursor 1003 being displayed around the title. A Back Button 614 is also shown in one of the embodiments of the present invention enabling the end-user to navigate back to the Application Composite 102 screen or Primary Categories 1000 listing when desired. The seven primary navigation toggles presented in FIG. 5 or variations thereof may appear in one illustration as in FIG. 10B according to one embodiment of the present invention.

FIG. 10C shows a more characterized Sub-Category Screen 1004. The demonstration in FIG. 10C is from the results of selecting the Sub-Category title 1006 “Brides and Weddings” shown in FIG. 10B. At the top of the characterized Sub-Category Screen 1004 may be a heading of displaying, Primary Category: Newsstand 1001. Below heading may display the name of the Sub-Category title 1006: Brides and Weddings with numerous rows of applications 1007 below the Sub-Category titles 1006: Brides and Weddings 1011. All the Sub-Category titles 1006 and the numerous applications 1009 listed under those Sub-Category titles 1006 may comprise a scroll feature to view them all respectively in their entirety in the embodiment of the present invention. A Back Button 614 is also shown in one of the embodiments of the present invention enabling the end-user to navigate back to the Sub-Category Screen 1004 when desired. The seven primary navigation toggles presented in FIG. 5 or variations thereof may appear in one illustration as shown in FIG. 10C according to one embodiment of the present invention.

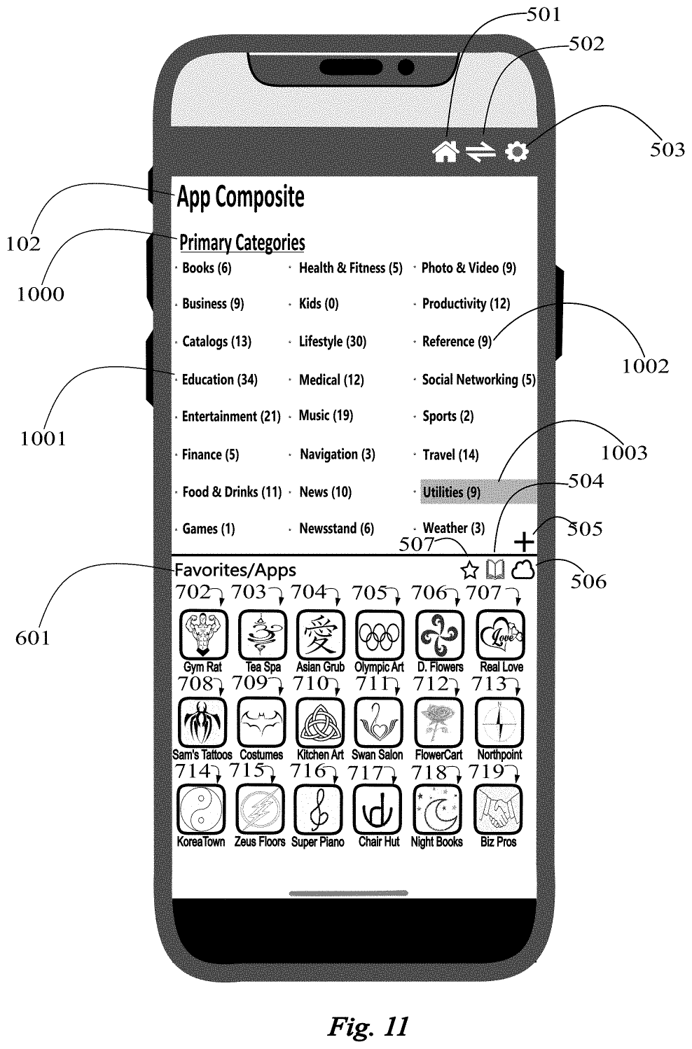

In one embodiment as depicted in FIG. 11 may reveal a completely different layout of the Application Composite 102 screen. The Primary Category heading 1000 may be in the same place as shown in FIG. 10A. However, the listing of each Primary Categories titles 1001 may appear in a different formation as shown in FIG. 11. The end-user may have the discretion to change the look and feel of the Application Composite 102 screen by tapping the Gear Symbol 503 for settings and the Knob Symbol 510 for “Preferences”. The Favorites/Apps Grouping 601 may exhibit several rows as shown in FIG. 11 by tapping the Star Symbol 507. The seven primary navigation toggles presented in FIG. 5 or variations thereof may appear in one illustration as in FIG. 11 according to one embodiment of the present invention.

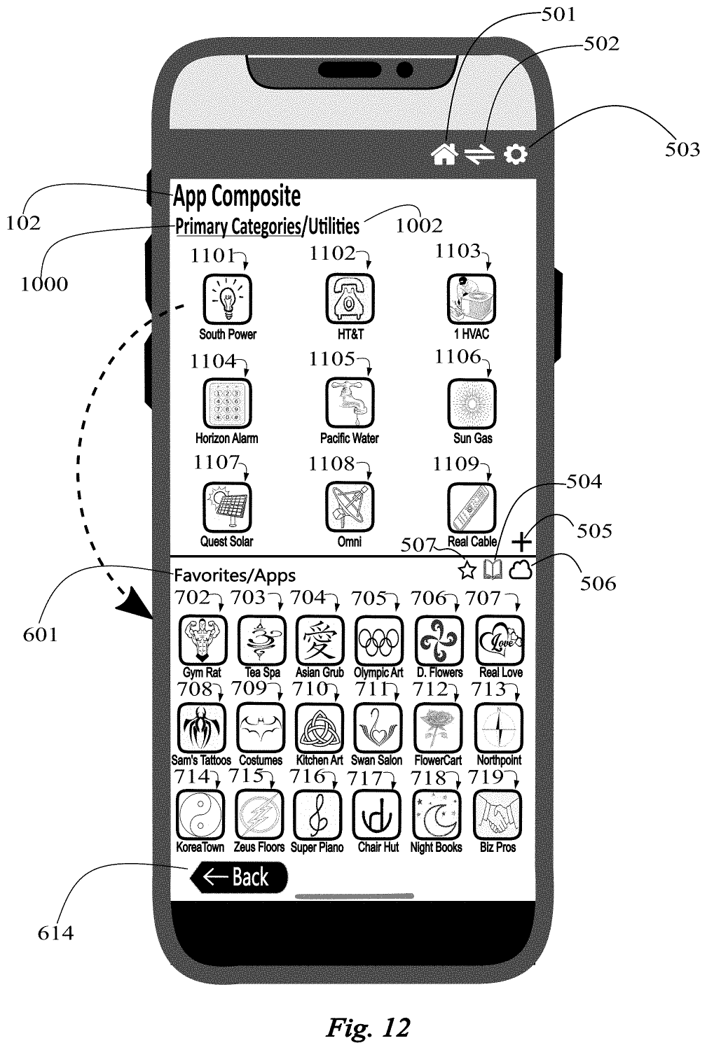

In FIG. 12 the Application Composite 102 screen may display an open category as in this instance the category described as Primary Category 1000: Utilities 1001. The cursor 1003 highlights nine applications saved under the Primary Category 1000: Utilities 1001 as depicted in FIG. 11. The nine applications that may be shown saved under Primary Category 1000: Utilities 1001 are: South Power 1101, HT&T 1102, 1 HVAC 1103, Horizon Alarm 1104, Pacific Water 1105, Sun Gas 1106, Quest Solar 1107, Omni 1108, and Real Cable 1109. There may be more, or fewer applications displayed on an Application Composite 102 screen, which may comprise a scroll feature to view them all in their entirety in one embodiment of the present invention. The Favorites/Apps Grouping 601 may exhibit a number of rows as shown in FIG. 12 by tapping the Star Symbol 507. An illustration of the embodiment as in FIG. 12 may show South Power 1101 being dragged to the Favorites/Apps Grouping 601 to appear in the front of the assemblage. A Back Button 614 may be shown at the bottom in one illustration to return to the previous screen. The seven primary navigation toggles presented in FIG. 5 or variations thereof may also appear in another illustration as in FIG. 12 according to one embodiment of the present invention.

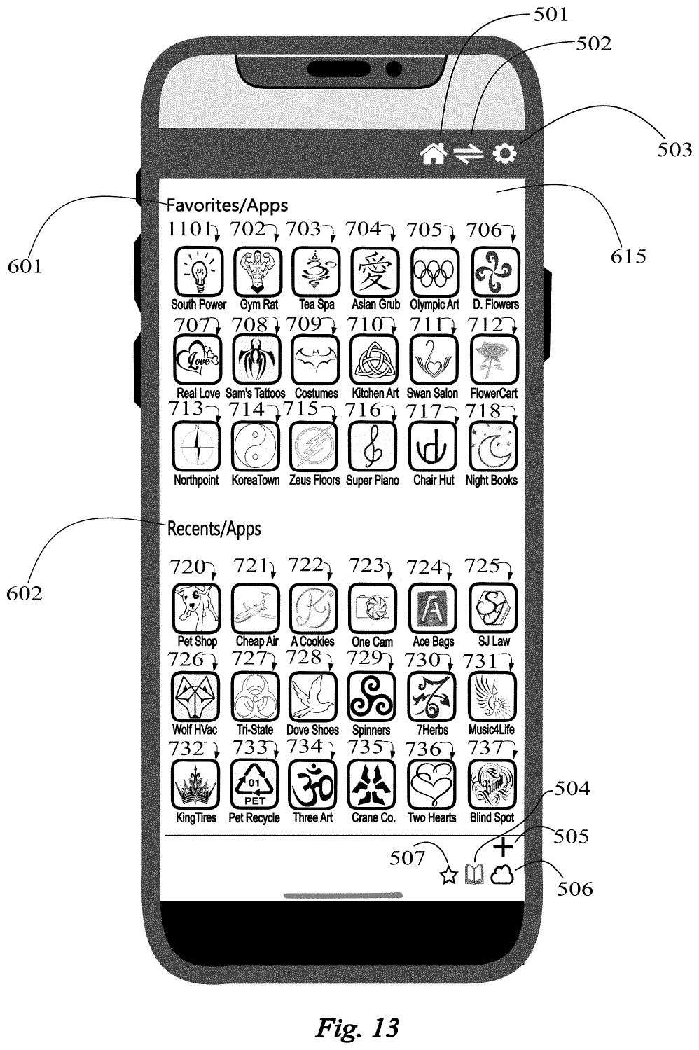

The home screen in FIG. 13 may display a new assortment of applications then what was illustrated in FIG. 7. The Favorites/Apps Grouping 601 shown in FIG. 13 may show different saved applications on home screen 615 with South Power 1101 newly exhibited as one of the applications under Favorites/Apps Grouping 601. The application titles in the illustration are as follow: South Power 1101, Gym Rat 702, Tea Spa 703, Asian Grub 704, Olympic Art 705, D. Flowers 706, Real Love 707, Sam's Tattoos 708, Costumes 709, Kitchen Art 710, Swan Salon 711, FlowerCart 712, Northpoint 713, Korea Town 714, Zeus Floors 715, Super Piano 716, Chair Hut 717, Night Books 718, with Biz Pros 719 no longer shown on the home screen 600. The Recents/Apps Grouping 602 may not show a change in FIG. 13 because no application was visited according to one embodiment of the present invention. All the applications listed on the Home Screen 615 may comprise a scroll feature to view them all in their entirety. The seven primary navigation toggles presented in FIG. 5 or variations thereof may also appear in another illustration as in FIG. 13 according to one embodiment of the present invention.

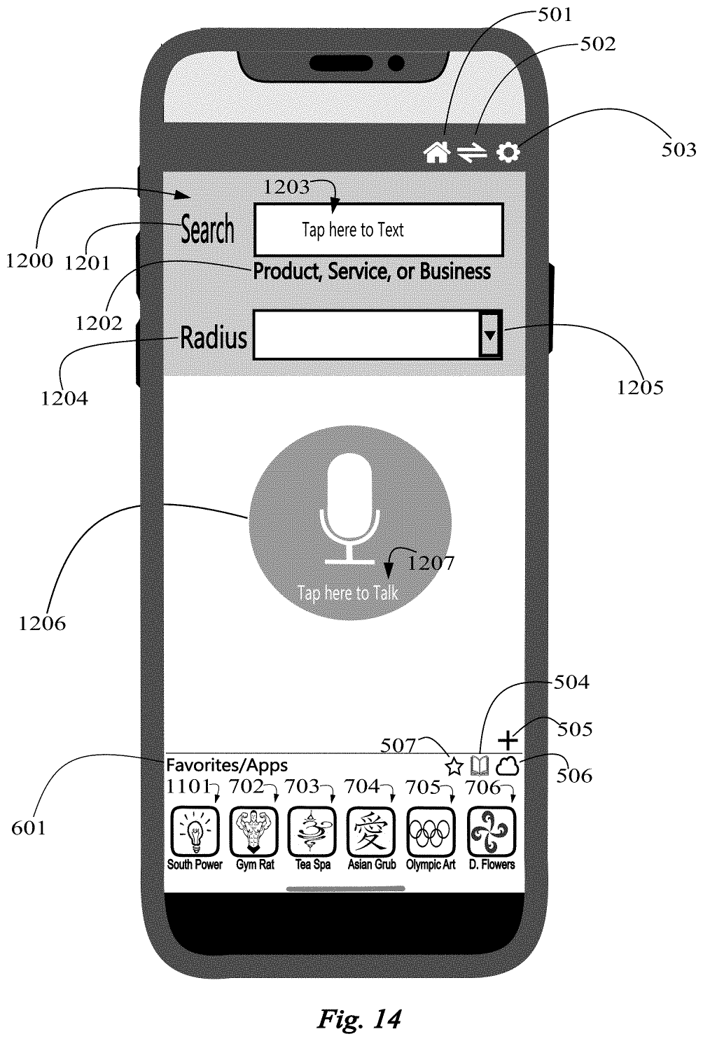

In FIG. 14 one embodiment of the invention may display a search radius screen 1200. A search frame may be displayed beside the word search 1201. Below the window may display the description Products, Services, or Business 1202. A phrase inside the frame may be the wording “Tap here to Text” 1203. A second frame may be displayed below the search frame 1201 with the word Radius by its side 1204. The radius frame 1204 may be assembled with a dropdown window 1205. In one embodiment a picture of a microphone 1206 may be displayed below the radius frame 1204. Directly below the microphone 1206 may be the wording “Tap here to Talk” 1207. The seven primary navigation toggles or variations thereof may appear in the illustration according to one embodiment of the present invention as well as the Favorites/Apps Grouping 601 as shown in FIG. 14 by tapping the star Symbol 507.

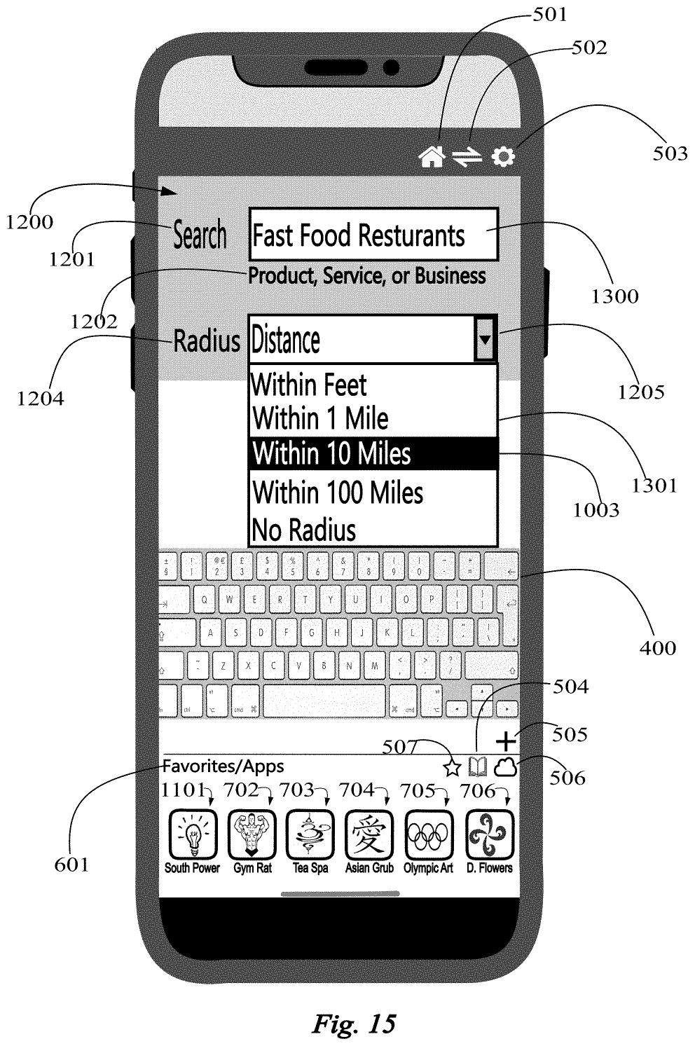

In FIG. 15 one embodiment of the invention may display a search radius screen 1200 where the search frame 1201 may have the words Fast Food Restaurants worded inside the frame 1300 as shown in FIG. 15. The Dropdown Window 1205 may display various radii 1301 from the mobile device's location. A cursor feature 1003 may be used to highlight the end-user's selection as illustrated in one embodiment in FIG. 15. Below the Dropdown Window 1205 may appear a keyboard 400 for typing in the wording “fast food restaurants” 1300. The seven primary navigation toggles or variations thereof may appear in the illustration according to one embodiment of the present invention as well as the Favorites/Apps Grouping 601 as shown in FIG. 15 by tapping the star Symbol 507.

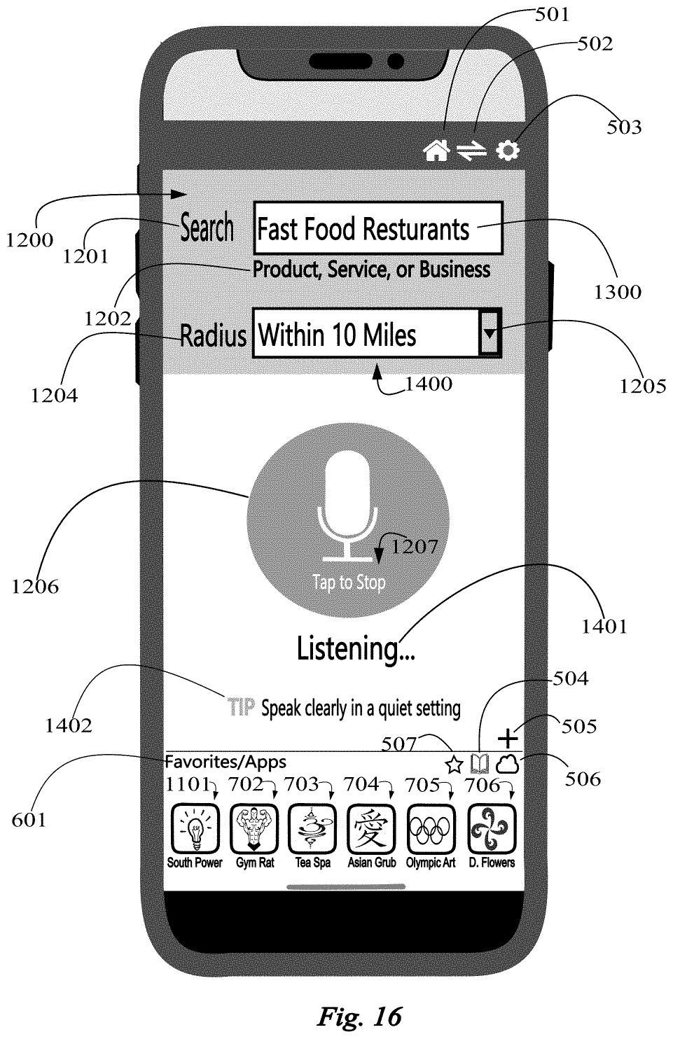

In FIG. 16 one embodiment of the invention may display a Search Radius Screen 1200 where the search frame 1201 may have the words Fast Food Restaurants worded inside the frame 1300 as shown in FIG. 16. The radius frame 1204 may display the wording inside the frame “within a 10-mile Radius” 1400. Below the picture of the microphone 1206 may be coherent listening device 1401 which may convey a single word to the end-user, “Listening” subsequently giving the end-user the command to speak. A suggested phrase may be added below the command to speak 1401 such as “TIP: Speak clearly in a quiet setting” 1402. The seven primary navigation toggles or variations thereof may appear in the illustration according to one embodiment of the present invention. A Favorites/Apps Grouping 601 may also be shown by tapping the Star Symbol 507 and/or a Recents/Apps Grouping 602 may appear on an embodiment by tapping the Books Symbol 504 in FIG. 16.

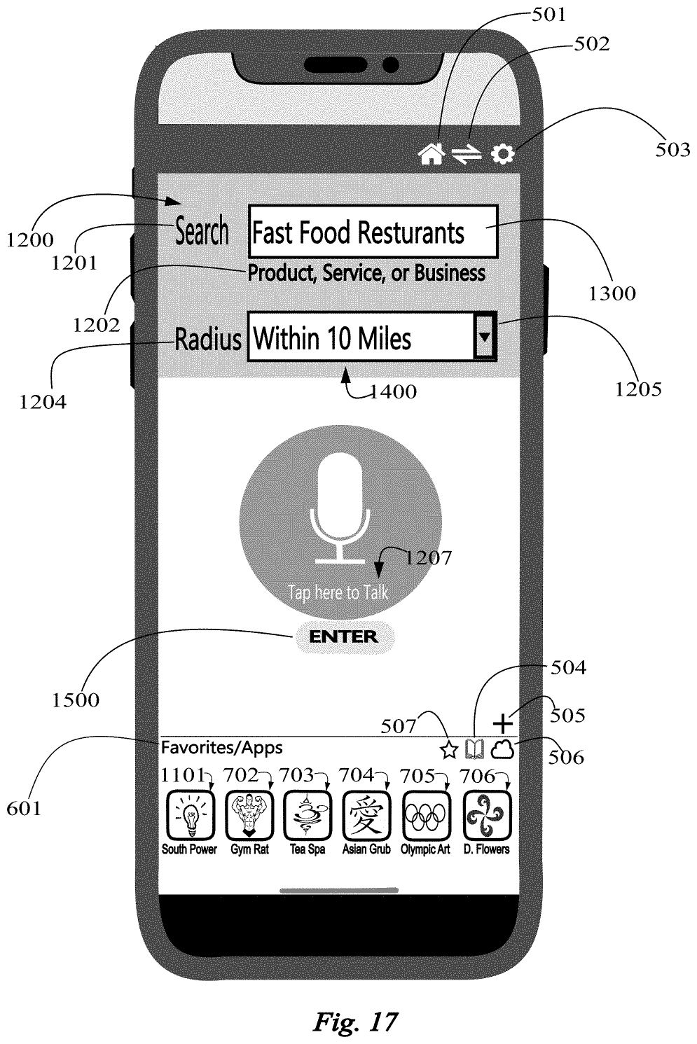

One embodiment of the invention may display an Enter Button 1500 below the microphone 1206 after the end-user has completed the command of the search shown in FIG. 17. The Enter Button 1500 may be the final task the end-user performs before retrieval of the search results. As shown in other embodiments seven primary navigation toggles or variations thereof may appear in the illustration according to one embodiment of the present invention. A Favorites/Apps Grouping 601 may also be shown by tapping the Star Symbol 507 and/or a Recents/Apps Grouping 602 may appear on an embodiment by tapping the Books Symbol 504 in FIG. 17.

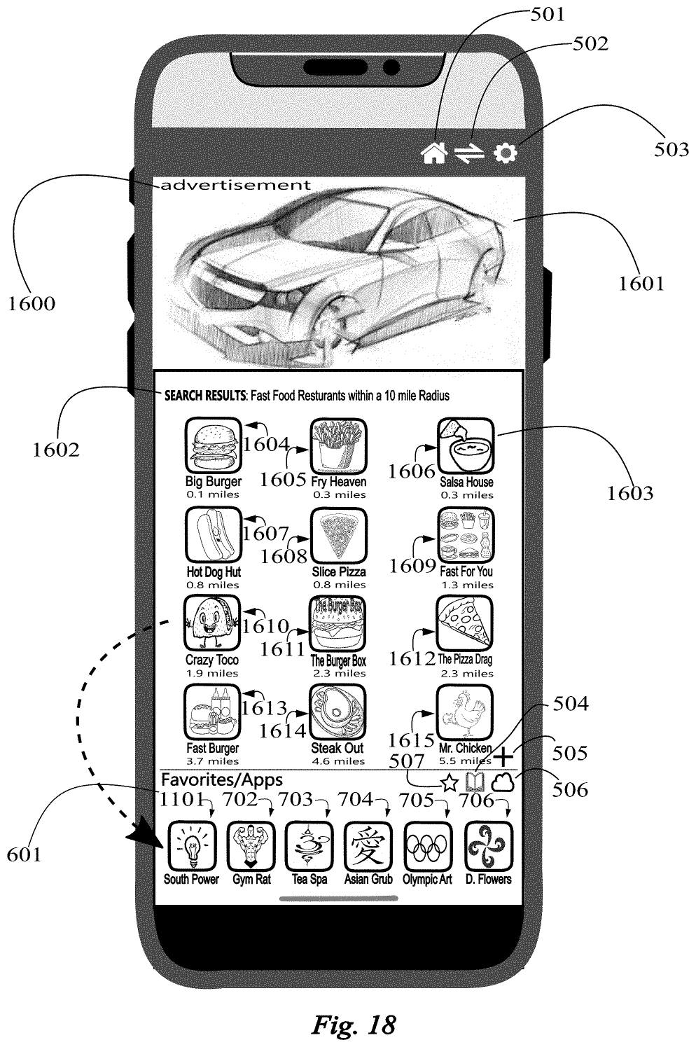

In FIG. 18 one embodiment of the present invention may display a search radius screen 1600. A search advertisement may be demonstrated at the top 1601 and below the search advertisement may be the wording, Search Results: Fast Food Restaurants within a 10-mile Radius 1602. One embodiment may exhibit a listing of fast food restaurant applications 1603 and the distances found from the search results. Each fast food restaurant application and its distances from the mobile device and end-user may show the search results as follow: Big Burger 0.1 miles, 1604, Fry Heaven 0.3 miles 1605, Salsa House 0.3 miles 1606, Hot Dog Hut 0.8 miles 1607, Slice Pizza 0.8 miles 1608, Fast For You 1.3 miles 1609, Crazy Taco 1.9 miles 1610, The Burger Box 2.3 miles 1611, The Pizza Drag 2.3 miles 1612, Fast Burger 3.7 miles 1613, Steak Out 4.6 miles 1614, and Mr. Chicken 5.5 miles 1615. All the applications listed on the search radius screen 1600 may comprise a scroll feature to view them all in their entirety. FIG. 18 also illustrates the end-user dragging the fast food restaurant Crazy Taco 1610 down to the Favorites/Apps Grouping 601. As shown in other embodiments seven primary navigation toggles or variations thereof may appear in the illustration according to one embodiment of the present invention.

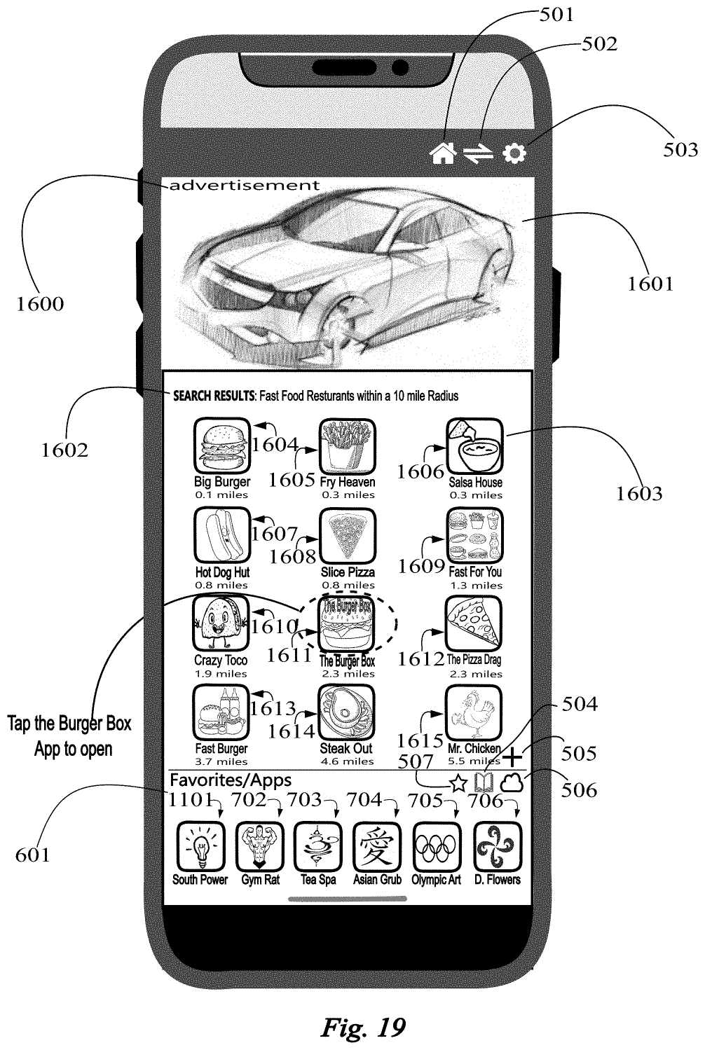

In one embodiment of the present invention as shown in FIG. 19 may illustrate as search radius screen selecting one fast food restaurant application from a listing of fast food restaurant applications 1603. The illustration shows The Burger Box 1611 as the end-user's selection. FIG. 19 also presents the newly added Crazy Taco 1610 under the Favorites/Apps Grouping 601. The search radius may have been broadened to restaurants, narrowed to burger restaurants, or simply “burgers” within a 10-mile radius in one embodiment of the present invention.

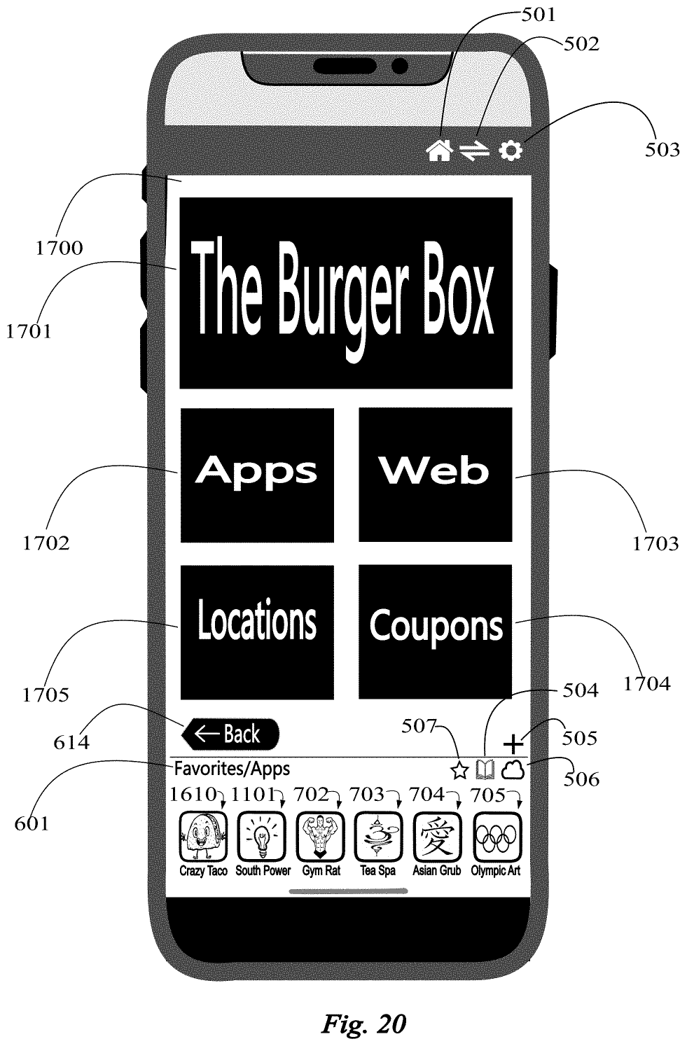

In one embodiment of the present invention as shown in FIG. 20 may illustrate a Navigations Screen 1700 for a business or brand if the business or brand was the element searched. The Navigations Screen 1700 may show the name of the business searched in the top box 1701, in which FIG. 20 illustrates the selected business and brand being “The Burger Box” 1611 from FIG. 19. Below the top box may be a list of options in form of boxes with each box serving as a portal into the business or brand's footprint. The two boxes directly below the top box. One box may be called “Apps” 1702, short for applications, which is the box underneath to the left, and the second box below to the right dubbed “Web” 1703, the abbreviation for websites. Below the second row of boxes may be a third row of boxes with each box being a product or service pertinent to the business or brand. Each business or brand may differ here depending on the nature of the business. In a fast food restaurant such as “The Burger Box, A “Locations” box 1705 may be of keen importance to the its brand's footprint as FIG. 20 illustrates in the box directly below the box labeled “Apps” 1702. A fourth box may be labeled “Coupons”1706 positioned to the right of it designed to increase traffic to the locations. Their maybe more, or fewer boxes displayed together on a Navigations Screen 1700 with the display comprising a scroll feature to view them all in their entirety. A Back Button 614 in the present embodiment may be needed on the navigation screen 1700 to restrict, enhance, or all together change the search. As shown in other embodiments seven primary navigation toggles or variations thereof may appear on the Navigations Screen 1700. A Favorites/Apps Grouping 601 may be on display by tapping the star Symbol 507, which further demonstrates the versatility of one embodiment of the present invention.

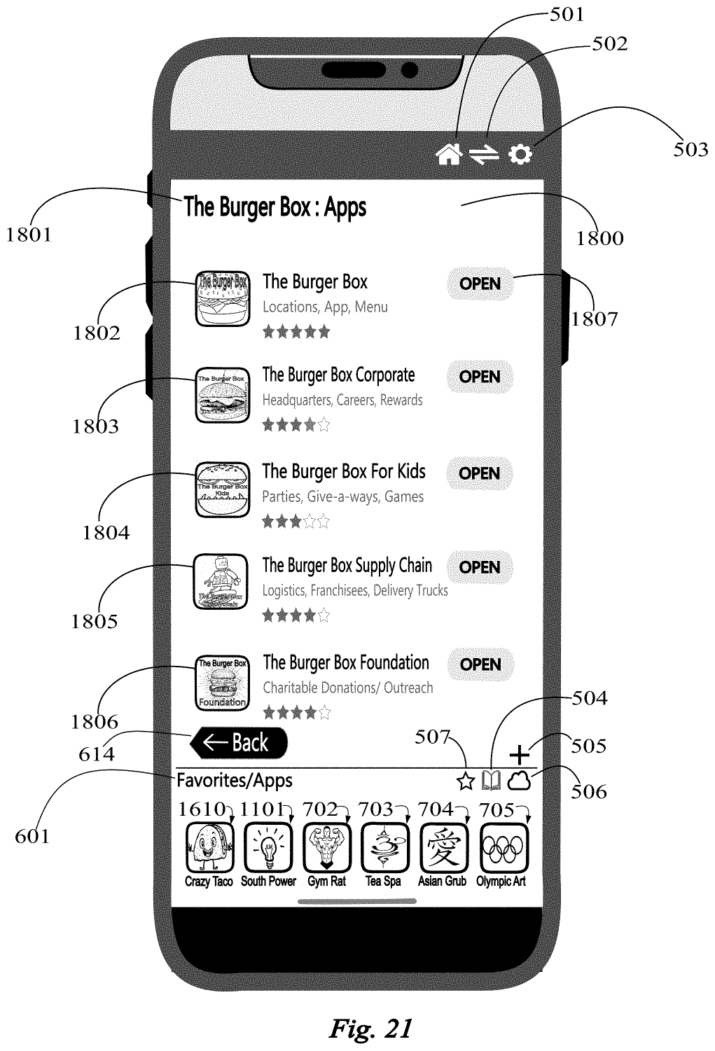

In one embodiment of the present invention FIG. 21 illustrates a business or Brand's Applications Screen 1800, which may catalog a list of every application under the business or brand's footprint. This screen may be routed to if Box 1 “Apps” 1702 is tapped in FIG. 20. At the top may be the name of the business or brand. The title may encompass the wording “The Burger Box: Apps” 1801. Below the title may be numerous applications listed in no logical order. Any of the applications may be opened by tapping the application directly or an open button 1807 beside it. The application may display a star rating below the icon of the application from previous visitor's experiences while on the application. Each application may display a different picture on the application tile with brief description written below describing the application's contents. The first application may be “The Burger Box” 1802, which may promote the products or services the business or brand produce. The second application may be “The Burger Box Corporate” 1803, which may be created for employees in the corporate structure. The third application “The Burger Box for Kids” 1804, may be particularly suited for children in the form of giveaways and games, or application to announce various events the brand may sponsor. The fourth application listed may be “The Burger Box Supply Chain” 1805, which may entail logistics for franchisees, the supply chain for their supply trucks and other operations. The last application listed in FIG. 21 may be “The Burger Box Foundation” 1806, created for charities, donations, and outreach. Their maybe more, or fewer applications displayed together on a business or Brand's Applications Screen 1800 with the display comprising a scroll feature to view them all in their entirety. A Back Button 614 may be added to go back to the previous screen. As shown in other embodiments seven primary navigation toggles or variations thereof may appear on the Applications screen 1800 for additional exits. A Favorites/Apps Grouping 601 may also be on display in one embodiment of the present invention as shown in FIG. 21.

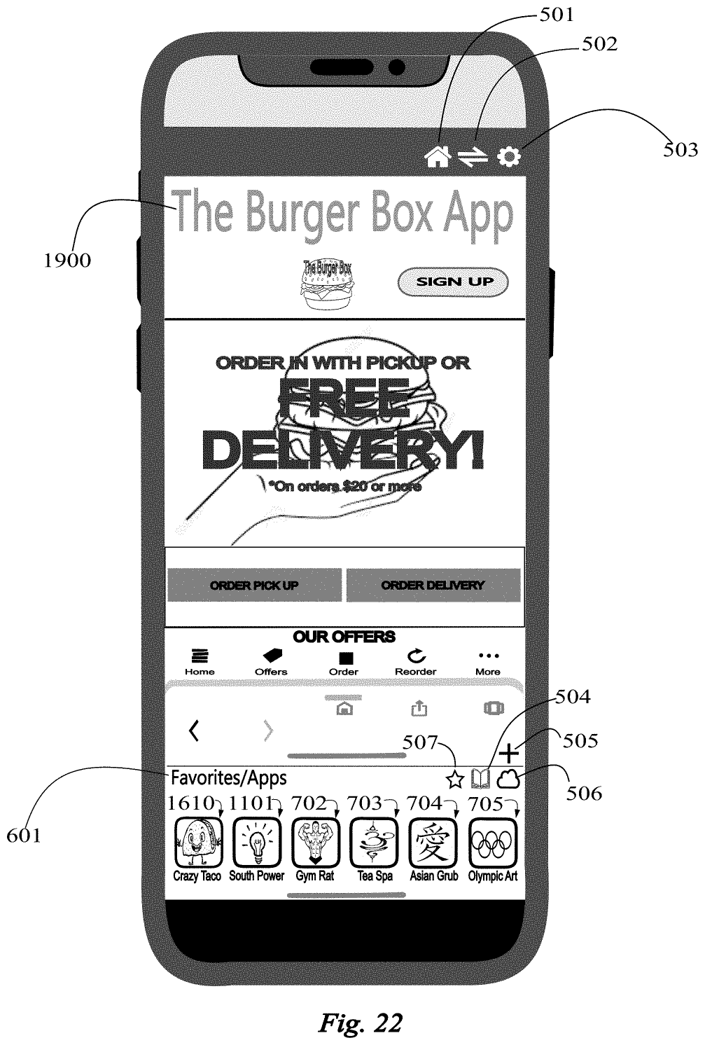

In one embodiment of the present invention may be an open Application's Landed Screen 1900 of a particular brand, as in FIG. 22, it being “The Burger Box” with a Favorites/Apps Grouping 601 on display while the application remain open as illustrated in FIG. 22 in one embodiment of the present invention. And as revealed in other embodiments seven or so primary navigation toggles may appear while the application remain open giving the end-user numerous options.

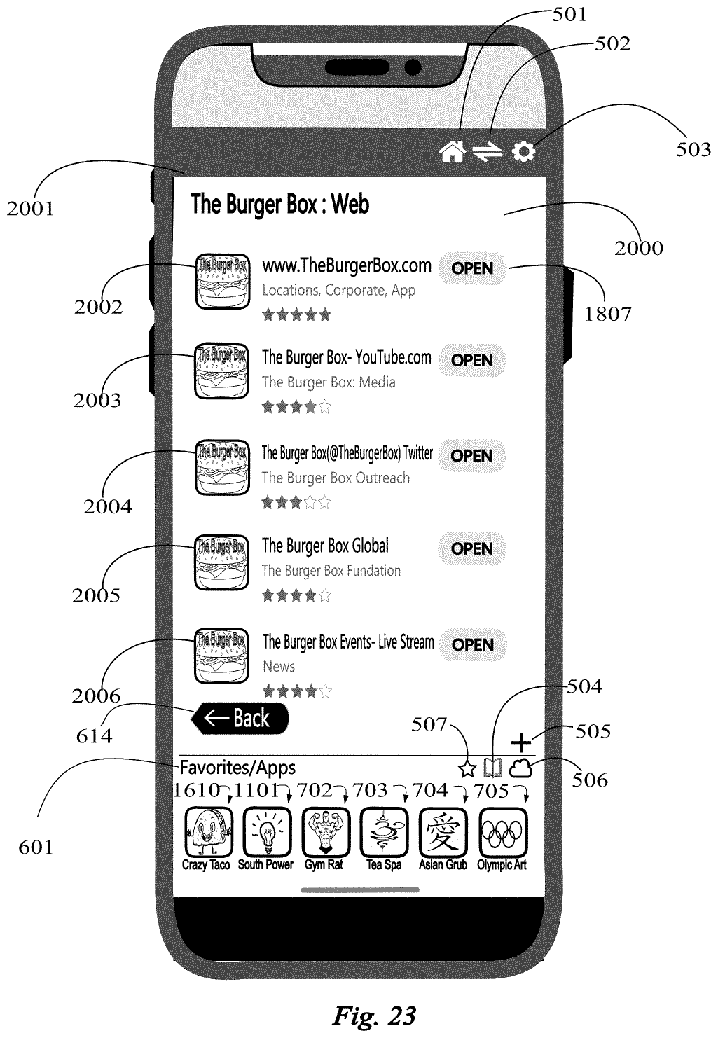

In one embodiment of the present invention FIG. 23 illustrates a business or brand's Web Base Screen 2000 routed from the navigation page. This screen may be directed to if Box 2 “Web” 1703 is tapped in FIG. 20. FIG. 23 a Web-Base Screen 2000 which may catalog a list of web base tiles under the business or brand's footprint. At the top may be the name of the business or brand. The title may encompass the wording “The Burger Box: Web” 2001. Below the title may be numerous web base tiles listed in no specified order. Any of the web base tiles may be opened by tapping the tile directly or an open button 1807 beside it. The web base tile may display a rating from previous viewer's experiences while visiting the website. Each web base tile may display a different picture on the tile with brief description written below describing the tile's contents. The first web base tile may be “TheBurgerBox.com” 2002, which may be the official website for the business or brand. The second web base tile may be “The Burger Box: YouTube.com” 2003, which may broadcast various content to promote the business or brand's reach. The third web base tile “The Burger Box: Twitter” 2004, may be on display to launch the business or brand's social media platform. The fourth web base tile listed may be “The Burger Box Global” 2005, which may entail a website that highlights the business or brand's global foundation. The last web base tile listed in FIG. 23 may be “The Burger Box: Event Live Stream” 2006, presented as a web base omni channel to promote brand awareness. Their maybe more, or fewer Web base icons displayed together on a Web-Base Screen 2000 with the display comprising a scroll feature to view them all in their entirety. A Back Button 614 may be added to go back to the previous screen. As shown in other embodiments seven primary navigation toggles or variations thereof may appear on the Web-Base Screen 2000 for additional exits. A Favorites/Apps Grouping 601 may also be on display in one embodiment of the present invention as shown in FIG. 23.

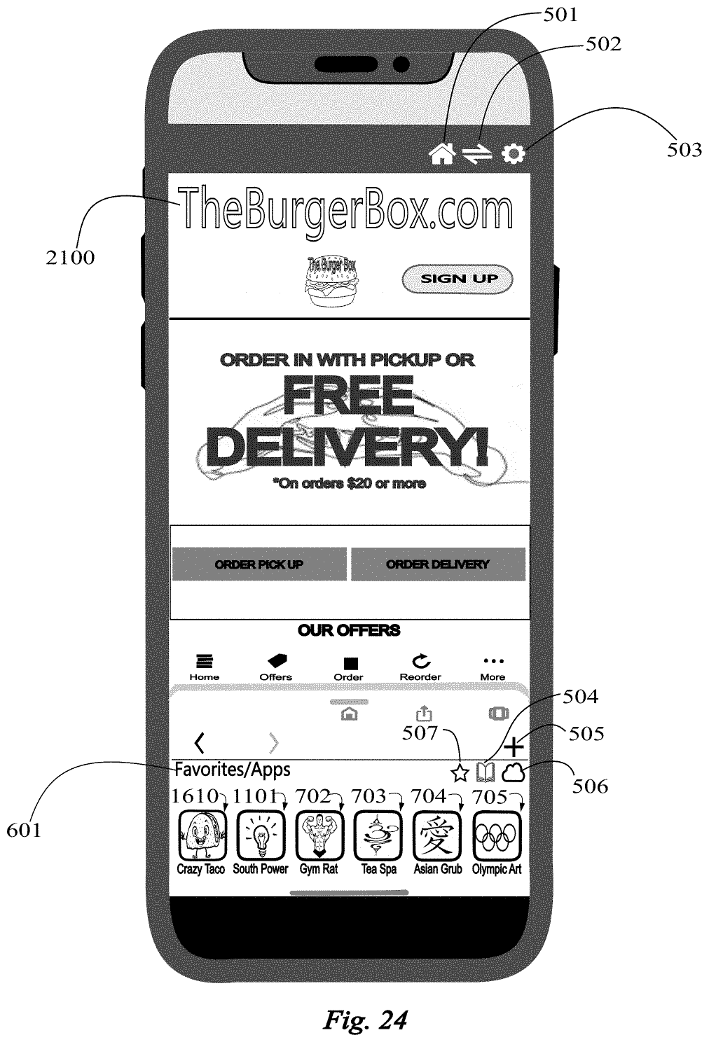

In one embodiment of the present invention may be an open website's landed screen 2100 of a particular brand, as in FIG. 24, it being “The Burger Box” with a Favorites/Apps Grouping 601 on display while the application remain open as illustrated in FIG. 24 in one embodiment of the present invention. There are seven or so primary navigation toggles as revealed in other embodiments that may appear while the application remain open, giving the end-user numerous options.

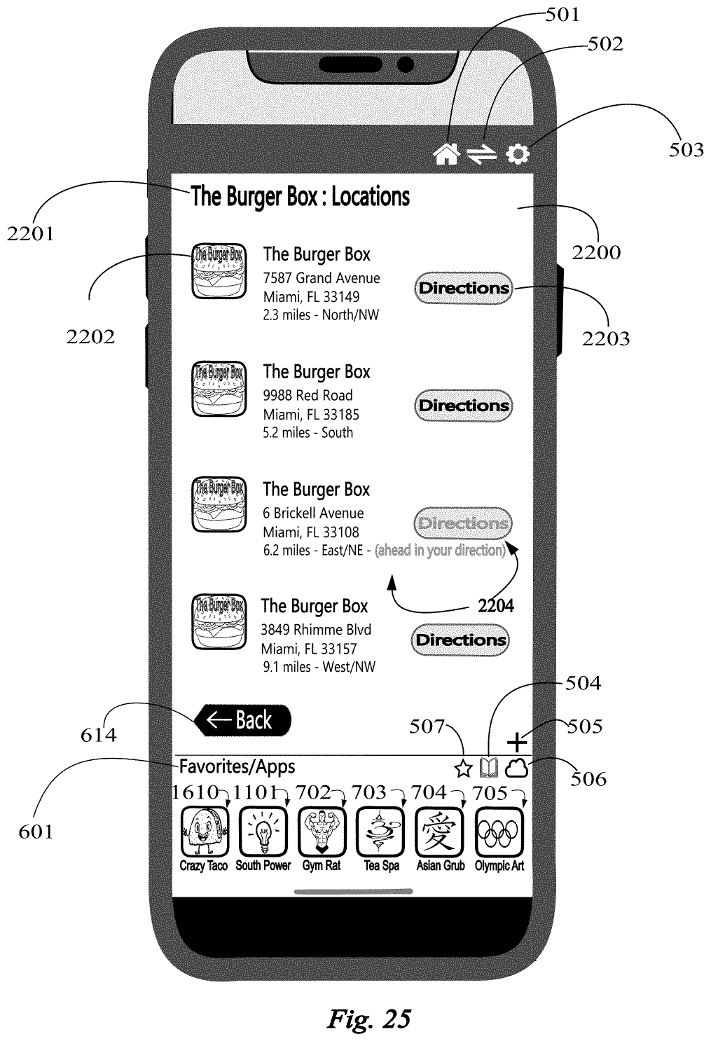

In one embodiment of the present invention FIG. 25 illustrates a business or brand's “Location” radii screen 2200 routed from the navigation page. This screen may be directed to if Box 3 “Locations” 1705 is tapped in FIG. 20. FIG. 25 a “Location” radii screen 2200 which may catalog a list of the business or brand's locations within a certain mile radius. At the top may be the name of the business or brand. The title may encompass the wording “The Burger Box: Locations” 2201. Below the title may be numerous location tiles listed in order of proximity to the mobile device. Any of the location tiles may be opened by tapping the tile directly or an “Directions” Button 2203 beside it. Each locations tile 2202 may display an address, the distance from the mobile device, and the area of the location spot all within the selected radius. Depending on the direction the end-user is headed, a location may be recommended by the navigation's software 2204. There maybe more, or fewer location icons displayed together on a Location radii screen 2200 with the display comprising a scroll feature to view them all in their entirety. A Back Button 614 may be found on the “Location” radii screen to go back to the previous screen. As shown in other embodiments seven primary navigation toggles or variations thereof may appear on the Web-Base Screen 2200 for additional exits. A Favorites/Apps Grouping 601 may also be on display in one embodiment of the present invention as shown in FIG. 25.

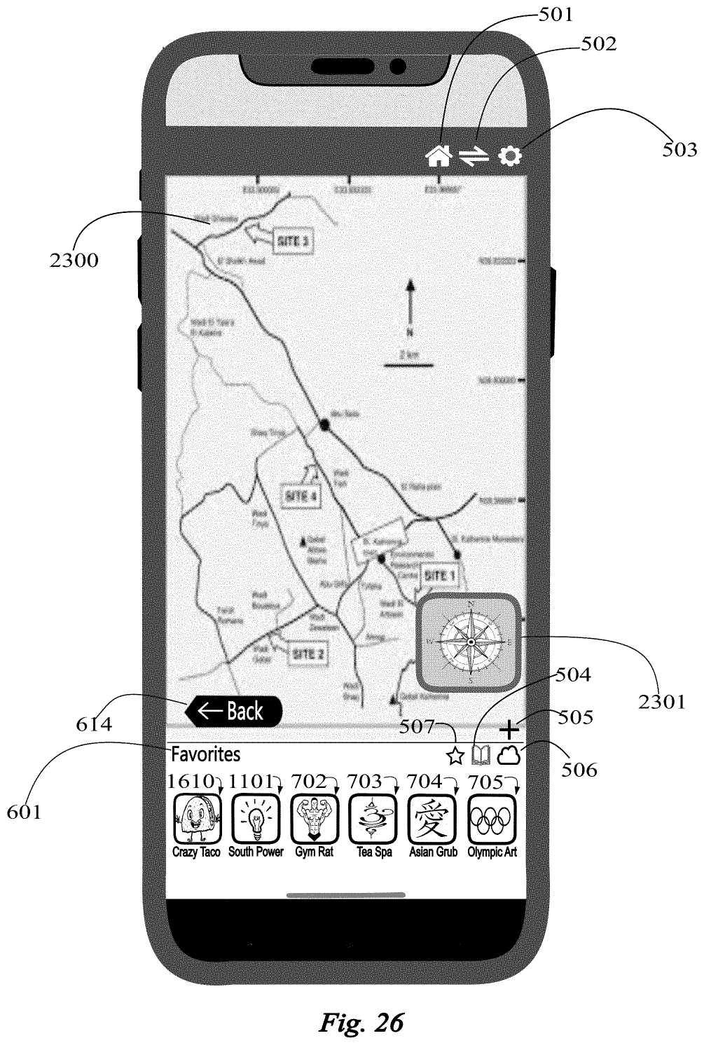

In one embodiment of the present invention may be GPS navigation screen 2300. The screen may display a compass 2301 with a Favorites/Apps Grouping 601 on display while the GPS navigation remain open as illustrated in FIG. 26 in one embodiment of the present invention. Furthermore, as revealed in other embodiments seven or so primary navigation toggles may appear while the application remain open giving the end-user numerous options.

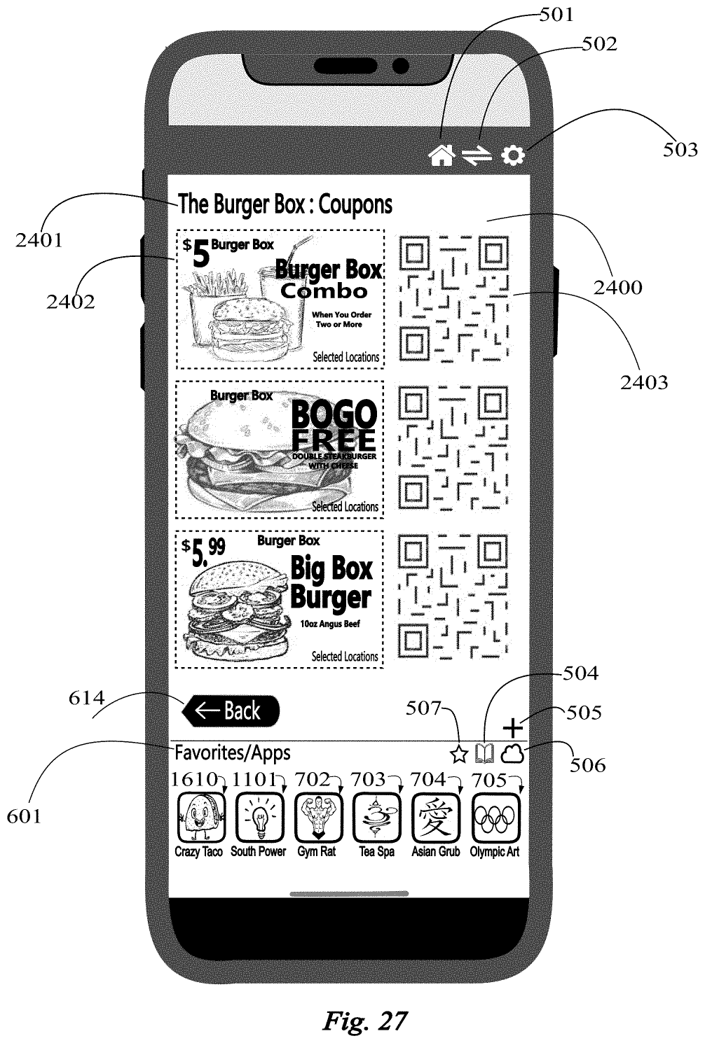

FIG. 27, in one embodiment of the present invention illustrates a business or Brand's Coupons Screen 2400. This screen may be directed to if Box 4 “Coupons” 1704 is tapped in FIG. 20. At the top may be the name of the business or brand. The title may encompass the wording “The Burger Box: Coupons” 2401. Below the title may be numerous Coupons and offers 2402 listed in no particular fashion. Any of the coupons may be redeemed with the QR Code 2403 positioned beside it. Their maybe more, or fewer coupons displayed together on a business or Brand's Coupons Screen 2400 with the display comprising a scroll feature to view them all in their entirety. A Back Button 614 may be found on the Coupons Screen 2400 to go back to the previous screen. As shown in other embodiments seven primary navigation toggles or variations thereof may appear on the Web-Base Screen 2200 for additional exits. A Favorites/Apps Grouping 601 may also be on display in one embodiment of the present invention as shown in FIG. 27. Any display screen of the present invention may appear with or without an application Grouping.

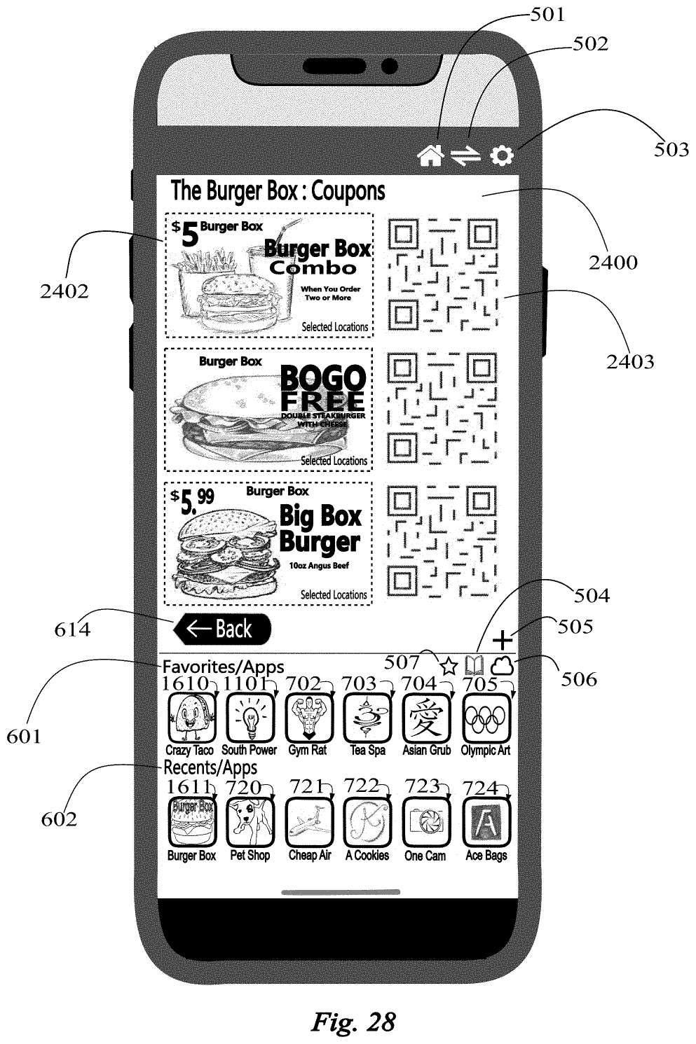

The two Groupings may appear coupled together as presented in FIG. 28. Subsequently, FIG. 28 as opposed to FIG. 27, present a Favorites/Apps Grouping 601 together a Recents/Apps Grouping 602 on the same screen in one embodiment of the present invention. These appearances are at the end-user's discretion. A single tap on the primary navigation toggle Book Symbol 504 may recall the Recents/Apps Grouping 602 to the screen as with a single tap on the primary navigation toggle Star Symbol 507 may recall the Favorites/Apps Grouping 601 to the screen. All the applications listed under any Grouping may comprise a scroll feature to view them all respectively in their entirety in the embodiment of the present invention.

FIG. 28 also show in one embodiment The Burger Box application 1611 as a new addition to the Recents/Apps Grouping 602. Since the Burger Box application 1611 was recently visited but not saved to the Application Composite 102. However, had the Burger Box application 1611 been saved to the Application Composite 102 it would have been displayed in the Favorites/Apps Grouping 601 as opposed to the Recents/Apps Grouping 602 in one embodiment of the present invention.

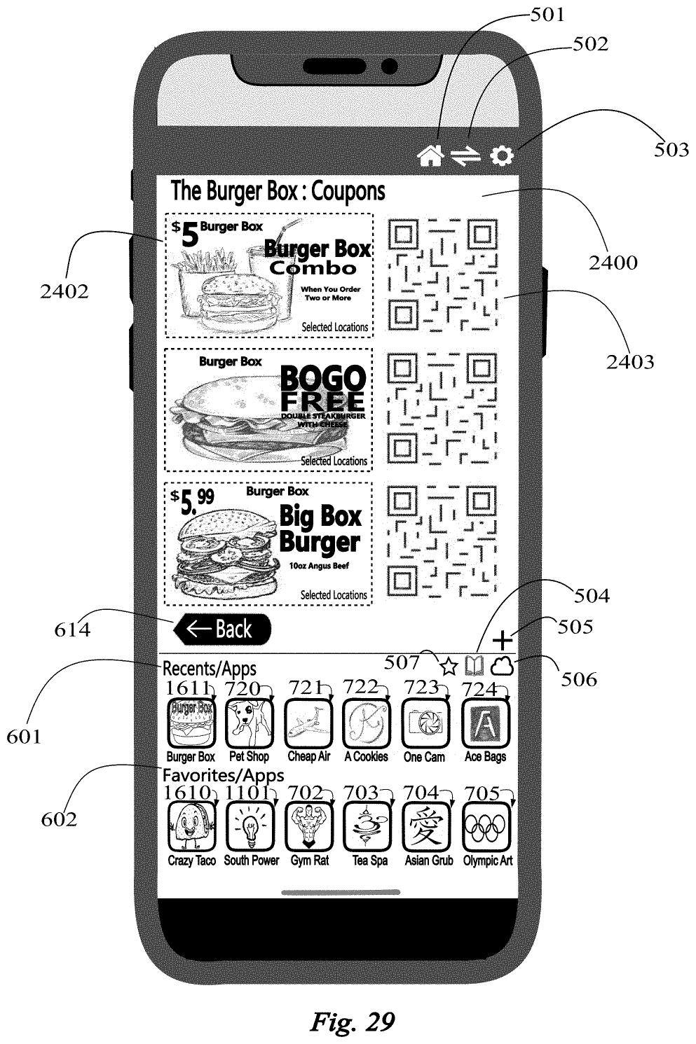

In one embodiment of the present invention one Grouping may appear on top of the other Grouping and in another embodiment of the present invention that Grouping shown on top in another embodiment may appear on the bottom, as FIG. 28 and FIG. 29 demonstrates with FIG. 29 showing a Recents/Apps Grouping 602 on top of a Favorites/Apps Grouping 601. A Grouping may be dragged from top to bottom of the other Grouping or vice versa by the end-user. Furthermore, a Grouping may be removed from the display screen by double tapping the designated Symbol to either.

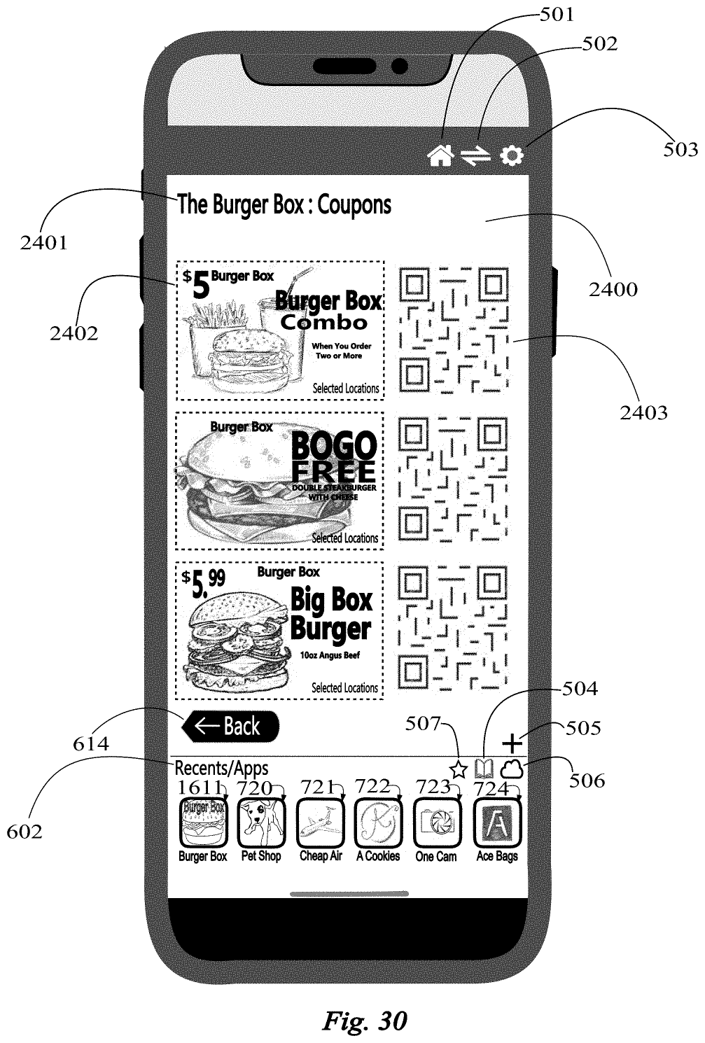

FIG. 30 further demonstrates, where a Recents/Apps Grouping 602 may be solely on the display in an embodiment from the illustration shown in FIG. 29, which depicts both Groupings together. Doubled tapping the primary navigation toggle Star Symbol 507 may remove a Favorites/Apps Grouping 601 from the display screen as FIG. 30 demonstrates.

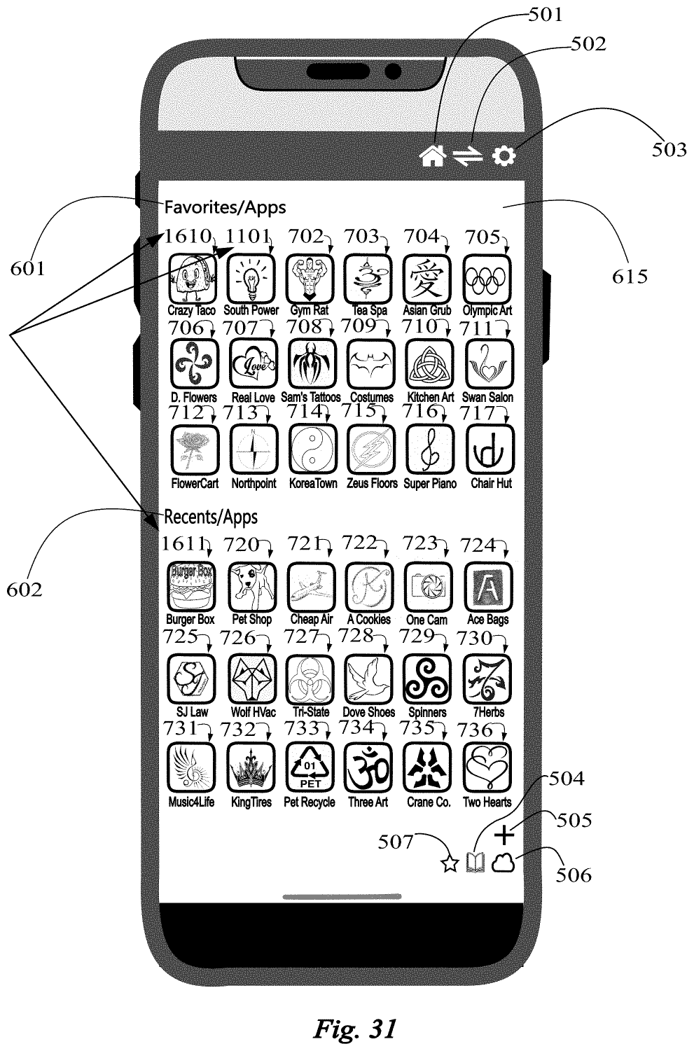

In one embodiment of the present invention FIG. 31 illustrates a Home Screen 615 with the newly addition applications under both the Favorites/Apps Grouping 601 and the Recents/Apps Grouping 602, respectively. South Power 1101 was added in a demonstration in FIG. 12. to a Favorites/Apps Grouping 601 and subsequently, Crazy Taco 1610 was added in FIG. 18 to the same Grouping. The new listing for Favorites/Apps Grouping 601 on a home screen 615 are Crazy Taco 1610, South Power 1101, Gym Rat 702, Tea Spa 703, Asian Grub 704, Olympic Art 705, D. Flowers 706, Real Love 707, Sam's Tattoos 708, Costumes 709, Kitchen Art 710, Swan Salon 711, FlowerCart 712, Northpoint 713, Korea Town 714, Zeus Floors 715, Super Piano 716, and Chair Hut 717. Moreover, FIG. 31 also further illustrates The Burger Box 1611 being added to a Recents/Apps Grouping 602. The new listing for Recents/Apps Grouping 602 on a home screen 615 are The Burger Box 161, Pet Shop 720, Cheap Air 721, A. Cookies 722, One Cam 723, Ace Bags 724, SJ Law 725, Wolf HVAC 726, Tri-State 727, Dove Shoes 728, Spinners 729, 7Herbs 730, Music4Life 731, KingTires 732, Pet Recycle 733, Three Art 734, Crane Co. 735, and Two Hearts 736.

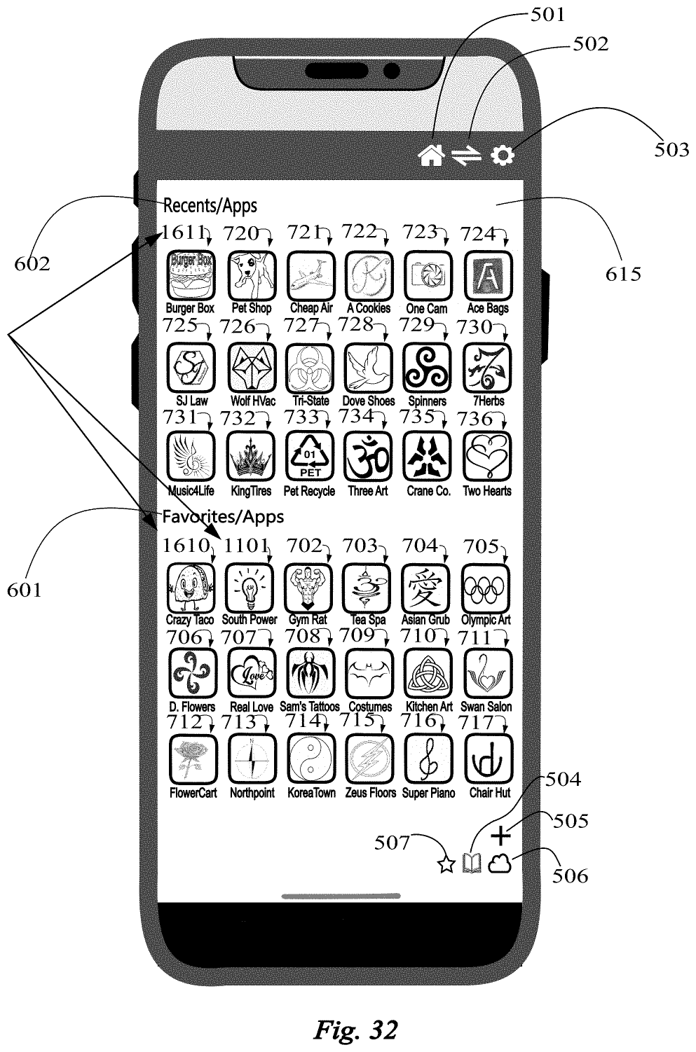

In FIG. 32 the home screen 615 as similarly demonstrated in FIG. 29 you can drag an entire applications Grouping from top to bottom of the other Grouping or vice versa by holding and dragging the Grouping by its name in one embodiment of the present invention, further illustrated in FIG. 32 as oppose to the contrasting exhibit in FIG. 31 with Recents/Apps Grouping 602 being displayed on top of Favorites/Apps Grouping 601.

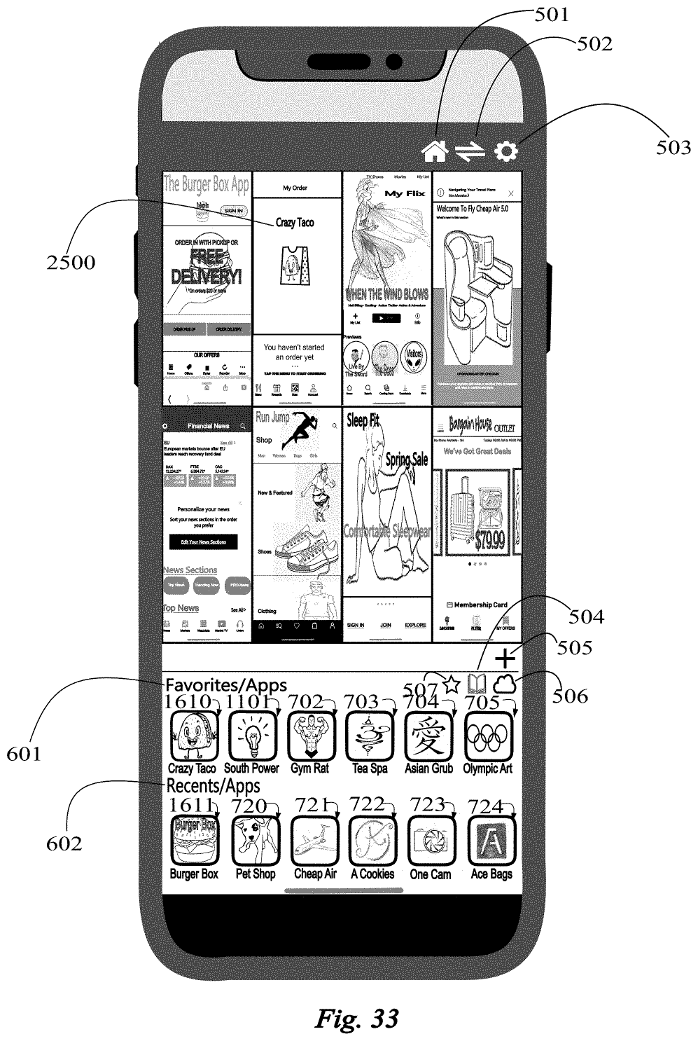

In one embodiment of the present invention FIG. 33 show a multiple applications screen 2500 which may reveal numerous applications shown opened on a single display. The demonstration in FIG. 33 can be revealed by double tapping the cloud icon 506 which may retrieve a blank screen in the Application Composite 102 with a Favorites/Apps Grouping 601, and/or a Recents/Apps Grouping 602 possibly shown below along the bottom of the screen. In each of the above embodiments of the present display (7) seven or so different navigation toggles to exit from the screen at a moment notice.

1. A system for enhancing mobile device performance, comprising:
a network-connected server;
software executing from a non transitory medium at the server providing an interactive interface for a user connected to the server via a downloadable application composite; and
a data repository cloud coupled to the server;
wherein the interactive interface provides an organizer for saving favorite applications under various categories and sub-categories and a history folder where unsaved recently visited applications are gathered and stored reducing application clutter on the mobile device's home screen, ease battery drainage, and free-up disk space in the mobile device's internal storage mechanism.

2. The system of claim 1 wherein an interface which can display a complete history of recently opened applications in a grouping format which are not saved or stored in the user's application composite.

3. The system of claim 1 wherein the end-user's application composite can be shown along with a favorites application grouping where the user can drag stored applications from the application composite to the favorites application grouping.

4. The system of claim 1 wherein the end-user is enabled to reveal a home screen illustrating both a favorites application grouping and a recents application grouping together on a single display.

5. The system of claim 1 wherein the end-user is enabled to reveal an application advertising screen along with a favorites application grouping and a recents applications grouping together on a single display.

6. A system for granting an end-user unrestricted access to other mobile applications, comprising:
a network-connected server;
software executing from a non transitory medium at the server via cloud providing a downloadable application composite for a user connected to the server through a data repository coupled to the server;
wherein an interactive interface and search radius mechanism provides a navigation window to a brand's footprint by way of numerous portals for an end-user to explore. The navigation window is used for proximity of location from the mobile device and for recalling applications and weblinks in the form of web-based icons that are held under a vendor.

7. The system of claim 6 wherein the end-user is enabled to search for products, services, or businesses in application form while showing a favorites application grouping and/or a recents application grouping exhibited together on a single display.

8. The system of claim 6 wherein the end-user is enabled to a search radius window for typing or with a built-in microphone for talking, and dropdown window showing the results for various distances for products, services, or businesses while showing favorites application grouping and/or recents application grouping exhibited together on a single display.

9. The system of claim 6 wherein the end-user is enabled to an interface revealing search results divulging the name and other pertinent information exhibited below each application with each application capable of being saved by way of hold the application down or dragging it to the favorites application grouping on the display.

10. The system of claim 6 wherein the end-user is enabled to a navigation screen with icons, setup as entryways to various access points to a brand's footprint while showing a favorites application grouping and/or recents application grouping exhibited together on a single display.

11. The system of claim 6 wherein the end-user is enabled to a portal to a registry of the various applications listed under the selected brand's name while showing a favorites application grouping and/or recents application grouping exhibited together on a single display.

12. The system of claim 6 wherein the end-user is enabled to a home screen of an open application while showing a favorites application grouping and/or recents application grouping exhibited together on a single display.

13. The system of claim 6 wherein the end-user is enabled to a portal to a registry of the various web-base icons that can be converted into applications and back again to web-based icons an instance which are generated as search results under a selected brand's name.

14. The method of claim 6 wherein the end-user is enabled to revealing the homepage of a brand's website while showing a favorites application grouping and/or recents application grouping exhibited on the display together.

15. The method of claim 6 wherein the end-user is enabled to the search radius results in the form of icons to a registry of the selected brand's various vicinities in proximity while showing a favorites application grouping and/or recents application grouping exhibited on the display together.

16. The method of claim 6 wherein the user is enabled to reveal a page with a variety of coupons and QR codes of the selected brand for redemption while showing a favorites application grouping and/or recents application grouping exhibited together on the display together.

17. The method of claim 6 wherein the user is enabled to revealed or retrieved a favorites application grouping and/or recents application grouping together on any display in claim 8.

18. An unrestricted system to open and close applications concurrently on a mobile device, comprising:
a network-connected server;
software executing from a non transitory medium at the server providing an interactive interface for a user connected to the server via a downloadable application composite; and
a data repository coupled to the server;
wherein the interactive interface provides a window showing various applications opened synchronously on a single display.

19. The method of claim 18 wherein the user is enabled to peruse opened applications by tapping, add to opened applications by dragging, and delete opened applications by swiping without affecting other opened applications on the same display.

20. The method of claim 1 wherein the user is enabled to revealed or retrieved a favorites application grouping and/or recents application grouping together on any display in the present invention.
